(19) United States
(12) Patent Application Publication
(10) Pub. No.: US 2003/0055727 A1
(43) Pub. Date: Mar. 20, 2003

(54) Method and apparatus for facilitating the provision of a benefit to a customer of a retailer

(76) Inventors: Jay S. Walker, Ridgefield, CT (US); Russell P. Sammon, San Francisco, CA (US); James A. Jorasch, Stamford, CT (US); Vikram R. Dendi, Pasadena, CA (US); Magdalena M. Fincham, Norwalk, CT (US)

Correspondence Address: WALKER DIGITAL, FIVE HIGH RIDGE PARK, STAMFORD, CT, 06905, US

(21) Appl. No.: 10/244,809

(22) Filed: Sep. 16, 2002

Related U.S. Application Data
(60) Provisional application No. 60/323,062, filed on Sep. 18, 2001.

(51) Int. Cl. G06F 17/60

(52) U.S. Cl. 705/14; 705/16; 705/26

(57) ABSTRACT

In accordance with one or more embodiments of the present invention, a customer participating in a purchase at a retailer is presented with an offer. The offer defines a benefit and an activity. The benefit is to be provided to the customer if the customer commits to the activity. A benefit may comprise, for example, a refund of a purchase total of the purchase during which the offer was output to the customer. The customer, at a time after the purchase during which the offer is output and after considering the offer, may accept the offer at a POS device or rebate device of the retailer. The benefit may be provided to the customer at the time of acceptance. The customer may be committed to the activity at the time of acceptance.

This application claims the benefit of priority of U.S. Provisional Patent Application Serial No. 60/323,062, filed Sep. 18, 2001, the content of which is incorporated by reference herein for all purposes.

### BACKGROUND OF THE INVENTION

The present invention relates to methods and apparatus for providing a benefit to a customer of a retailer. Further, the present invention relates to means of marketing products and services to customers.

Retailers are always looking for means of acquiring additional revenue. Raising prices as a means for increasing revenue is limited by customers' willingness to pay higher prices and by the prices at which customers may acquire comparable products from competitors. Lowering prices, while attracting customers, typically results in decreased revenue for retailers.

Various companies and marketers are always looking for effective means of acquiring new customers. Traditional methods of advertising have limited effectiveness because in today's aggressive marketing world customers are constantly bombarded with advertisements. Further, customers are typically not sufficiently personally motivated to respond to traditional advertisements when they perceive them.

Customers are always looking for means of avoiding costs and lowering their expenditures. However, customers have limited means for avoiding costs and/or lowering expenditures while still acquiring the products and services they desire.

Accordingly, a need exists for a means of marketing products and services to customers which sufficiently motivates the customers, provides an additional source of revenue to retailers, and/or allows customers to lower their expenditures while acquiring the products and services they desire.

### BRIEF DESCRIPTION OF THE DRAWINGS

FIG. 1 is a block diagram of a system consistent with an embodiment of the present invention.

FIG. 2 is a block diagram of an embodiment of a device of the system of FIG. 1.

FIG. 3 is a table illustrating an exemplary data structure of a subsidy database for use in an embodiment of the present invention.

FIG. 4 is a table illustrating an exemplary data structure of a purchase database for use in an embodiment of the present invention.

FIG. 5 is a table illustrating an exemplary data structure of an offer database for use in an embodiment of the present invention.

FIG. 6 is a table illustrating an exemplary data structure of a redemption database for use in an embodiment of the present invention.

FIG. 7 is a table illustrating an exemplary data structure of a customer database for use in an embodiment of the present invention.

FIG. 8 is a flowchart illustrating a process that may be performed with the system of FIG. 1.

### DETAILED DESCRIPTION OF THE INVENTION

Applicants have recognized that various companies set aside a customer acquisition budget and/or a customer retention budget. The monies in such budgets are expended on promotional efforts aimed at attracting new customers for a business and convincing existing customers of a business to remain customers of that business. Typically, such promotional efforts consist of advertising through various media (e.g., television, radio, newspapers, billboards). Sometimes, attempts are made at increasing the effectiveness of such advertising by targeting it at customers that fit a certain profile (e.g., direct mailings and television advertisements aired during particular shows based on demographic information). However, in such advertising the marketers and businesses are at the mercy of luck as to whether a customer will respond to the advertising.

Applicants have also recognized that whether a customer will respond to an advertisement typically depends on whether a customer is in some manner personally motivated to respond to an advertisement at the time he or she is exposed to it. For example, an advertisement for a particular product or service will typically be more effective when viewed by a person considering a purchase of the product or service. In another example, offering a person a discount on a product while the person is in the process of purchasing the product (e.g., in exchange for the person's agreement to view an advertisement or purchase another product) is particularly effective because the person is motivated at that particular time to obtain the discount and reduce the cost incurred for purchasing the product. Methods that take advantage of the latter type of motivation are disclosed in co-pending U.S. patent application Ser. No. 09/282,747, filed Mar. 31, 1999. There is a need for methods that make more effective use of the customer acquisition and customer retention budgets of businesses.

Applicants have also recognized that many customers are motivated to avoid costs associated with purchasing goods and services they desire and are willing to perform certain tasks in order to accomplish this. For example, many customers spend time clipping coupons or visiting different stores that sell the same product in order to pay the lowest price for the product or service they desire. However, the businesses that provide low prices and/or coupons are dependent on the customers' having the initiative to seek out the low prices and/or coupons. Accordingly, customers that do not take the initiative are lost to businesses that offer deals in order to attract customers motivated by saving money. Thus, a need exists for a method of attracting customers who do not take the initiative.

Applicants have also recognized, however, that even customers that do not take the initiative in actively seeking out deals would like to avoid the cost of paying for whatever product or service they are purchasing or have just purchased. In fact, some customers return products they have purchased based on the sole motivation of avoiding the cost of the product (e.g., after spending the money and feeling guilty about it). However, in order to avoid such costs the customer has to give up the product or service. Further, certain types of purchases do not lend themselves to being returned. For example, consumable products (e.g., a meal at a quick service restaurant) are typically not returnable (especially once the customer has begun enjoyment of the product).

Another example of how motivated customers are to avoid or reduce costs and to obtain a return of money they spent on a purchase is the success of rebates in motivating customers to purchase a product. A rebate is an offer that allows a customer to obtain some of the purchase price of a product back after having purchased the product. The customer typically has to send in a documentation of the rebate (e.g., a form the customer fills out) along with a proof of purchase of the product for which the rebate is offered (e.g., a receipt or code from the package of the product). However, while many customers are typically initially motivated to purchase a product by the availability of a rebate, the inconveniences of taking advantage of the rebate (e.g., filling out the form, saving the receipt, mailing the documentation to the manufacturer) keep many customers from realizing the benefits of the rebate. Further, even when customers do perform all the requirements of obtaining a rebate it sometimes takes weeks or even months to obtain the funds. In fact, some customers complain of never actually obtaining their money back even after having mailed in the documentation as required by the rebate offer.

Such delays and unsuccessful attempts associated with redeeming rebates are recognized by many customers who, after bringing the product and rebate offer home, decide that it is not worth the hassle to actually mail in the documentation. However, the fact that a significant number of customers are still initially motivated to purchase a product by the mere possibility of obtaining a rebate is a testament to how powerful the motivation to avoid a cost or to obtain at least a partial refund of funds while retaining the purchased product can be.

Applicants, in prior U.S. Patent Applications, have recognized that presenting a customer with an offer for a benefit that allows a customer to avoid at least a portion of a transaction cost while the customer is completing a transaction is an effective method of marketing products and services to customers. For example, in U.S. patent application Ser. No. 09/282,747, Applicants have disclosed embodiments wherein a customer at a point-of-sale is presented with an offer that allows the customer to obtain the product or service the customer is in the midst of purchasing without paying anything for it, if the customer commits to an activity in lieu of the payment. For example, a customer purchasing a book at an online bookstore may be presented with an offer that allows the customer to obtain the book for free, if the customer commits to a free trial subscription to a magazine. Applicants have recognized that customers in such situations are particularly motivated to accept such an offer in order to avoid the cost of what it is they are purchasing. Applicants have also recognized that some businesses would be willing to spend at least a portion of their customer acquisition and/or customer retention budgets on presenting such offers to customers. For example, a magazine publisher may be willing to pay the online bookstore the price of the book (e.g., plus an extra bonus amount) in exchange for the ability to present the offer for the free trial subscription to the customer and/or in exchange for the customer's acceptance of the free trial subscription. This is true because a magazine publisher recognizes that a customer who receives a magazine as part of a free trial subscription has a likelihood of subscribing to the magazine after the trial is over. This is further true because, in the magazine industry, the magazine publisher's revenues from advertisers increase as the number of readers of the magazine increase (regardless of whether the readers are paying ones).

Applicants have recognized, however, that there are some business environments where it may not be practical and/or desirable to present customers with such offers for benefits in exchange for the customers' commitment to an activity while the customers are completing purchases. For example, in a business where keeping the time an individual customer spends at a point-of-sale to a minimum is particularly important (e.g., a quick service restaurant, a grocery store, a drive-thru service), an operator of such a business may be reluctant to present offers for the consideration of customers. Also, Applicants have recognized that, for some offers that allow a customer to obtain a benefit in exchange for a commitment to an activity, it may be desirable to allow the customer some time to consider the offer. For example, an offer may present the customer with a choice and/or may specify some terms that a customer may prefer to read at his or her leisure before responding. Having customers consider certain offers at a point-of-sale may result, for example, in longer waiting times for other customers and in fewer transactions per unit of time. Thus, some retailers may feel that the delay that may result from presenting certain offers may outweigh the profit and goodwill that the retailer may obtain as a result from presenting the offers. Further, customers may be less likely to accept certain offers if they feel rushed or pressured into making a decision at a point-of-sale.

Accordingly, the present Application discloses embodiments that allow a customer to be presented with an offer at a time when the customer is personally motivated to accept the offer (e.g., at a time the customer is completing a purchase) while allowing the customer time to consider the offer and, after so considering it, accept the offer and obtain a benefit. Such a benefit may comprise, for example, a refund of at least a portion of a purchase price associated with the purchase. Further, to increase the likelihood and ease that a customer will take advantage of such an offer, the present Application discloses embodiments wherein a customer may accept such an offer at a point-of-sale device or other device located at the business where the customer completed the purchase within a predetermined time of completing the purchase.

In general, in an embodiment of the present invention a customer completing a purchase with a retailer is presented with an offer. The offer defines a benefit to be provided to the customer in exchange for the customer's commitment to an activity. The benefit may comprise, for example, a refund of the amount paid by the customer during the purchase at which the offer was presented. In other embodiments the benefit may be another cash amount or other benefit. If, after completing the purchase, the customer desires to accept the offer, the customer indicates an acceptance of the offer and provides an indication of the previous purchase to a device or employee of the retailer. For example, the customer may present an identifier that identifies the offer the customer desires to accept along with the receipt of the previous purchase to an operator of a point-of-sale device of the retailer. An indication of the customer's acceptance of the offer (and thus commitment to the activity) may be stored in a memory. The customer may then be provided with the benefit (e.g., a refund of the purchase total of the previous purchase).

In one illustrative example of the present invention, a customer purchasing a meal at a quick service restaurant may be provided with one or more offers printed on a paper placemat (hereinafter a “trayliner”) placed on a tray containing the customer's meal. The customer, after paying for the meal and being provided with a receipt, may sit down at a table of the quick service restaurant and peruse the one or more offers on the trayliner while eating his meal. At least one of the offers may allow the customer to receive the payment for the meal back if the customer agrees to a free trial membership for a magazine subscription. The actual amount of money the customer is to receive if the customer accepts the offer may or may not be printed on the placemat. For example, the offer may specify that the customer can “get his money back for the meal you just purchased, up to $10.00” if he agrees to the magazine subscription. In such embodiments, the actual amount that the customer receives upon accepting the offer may be determined based on the purchase total of the customer's previous transaction (e.g., as determined from the receipt of the previous purchase). Such an offer may be utilized in embodiments where the trayliners are printed before the purchase and are thus not customized to the customer's purchase.

In other embodiments, the trayliner (or a portion thereof) may be printed based on the customer's purchase and thus specify the exact amount the customer is to receive if he or she accepts the offer. For example, an offer printed on the trayliner may specify that the customer can “get back the $5.49 you just spent for this meal” if the customer agrees to the free magazine trial subscription. After considering the offer while finishing his meal, the customer may decide to accept the offer. For example, after finishing his meal the customer may feel that he spent his money and no longer has anything to show for it (the meal being now gone). Not feeling the hunger pangs anymore, the customer may prefer to have the money back in his pocket. Applicants have recognized that purchasers of consumable products may be particularly motivated by an opportunity to obtain the payment for the product back. This is because at a certain point the purchaser is left with no product and no cash (e.g., once the purchaser consumes the product by using it as intended) and may regret having spent the money without now having anything tangible to show for it.

In accordance with an embodiment, the customer may need to provide contact information and/or information that identifies the customer when accepting the offer. For example, the customer may need to present at least one of a driver's license, a social security number, a financial account identifier, a name, a postal address, an electronic mail address, and a telephone number. In accordance with an embodiment the identity of the customer to whom the benefit is provided may be documented by means other than information provided by the customer directly. For example, a photographic image of the customer may be captured using a still-image or video camera located at the retailer.

A customer accepting an offer in accordance with an embodiment of the present invention may be required to fill out some information (e.g., name, e-mail address, telephone number) on a form associated with the offer before accepting the offer. In some embodiments the activity the customer must commit to in order to accept the offer comprises a survey. In such embodiments the survey questions may be printed on the trayliner and the customer required to answer the survey questions as part of the acceptance of the offer.

Continuing with the above example, the customer may bring the trayliner or a portion thereof (e.g., the offer may be printed on a perforated area of the trayliner) along with the receipt from the previous purchase to a point-of-sale (POS) device of the restaurant. The operator of the POS device may enter an identifier of the offer (e.g., by scanning a barcode printed on the trayliner) and an identifier of the purchase (e.g., printed on the receipt) into the POS device. The POS device may then retrieve the purchase total of the purchase from memory (e.g., memory of the POS device or memory of another device the POS device is in communication with).

The POS device may perform one or more verification checks when processing a customer's acceptance of an offer. For example, the POS device or another device the POS device is in communication with may determine whether the acceptance of the offer is within a predetermined time of the previous purchase, verify that the offer was output to the customer during the previous purchase, verify that the customer has not previously accepted this offer, and/or that the customer has not reneged on a previously accepted offer. Once the verification checks, if any, are successfully completed, the POS device may authorize the operator to provide the customer with an amount of cash from the register drawer (or another benefit defined by the offer). The amount of cash may be, for example, the purchase total of the customer's previous purchase. The customer's acceptance of the offer may be stored in a memory (e.g., of the POS device or another device the POS device is in communication with). The receipt of the previous purchase, along with documentation of the accepted offer (e.g., the perforated section of the trayliner on which the offer was printed) may be obtained from the customer and placed in the cash register drawer of the POS device, for future offer acceptance verification purposes. The POS device may store an indication of the exact amount of cash that was authorized to be removed from the drawer in association with the purchase identifier, the offer identifier, and/or a customer identifier.

Continuing with the example, the quick service restaurant may be compensated for the cash amount provided to the customer by a magazine publisher or other entity that is funding the offer. The quick service restaurant may further be compensated or paid for an amount beyond the cash amount provided to the customer (e.g., as payment for access to the customer and/or for overhead costs of facilitating the offer). Thus, the magazine publisher or other entity that funded the offer effectively marketed a product (the free trial magazine subscription) to a customer that was personally motivated to consider and accept the offer (by the desire to get his money back for the meal). The customer essentially obtained a free meal and walked out of the restaurant with his hunger satiated and the same amount of money in his pocket as when he walked in. The retailer satisfied a customer and realized the full profit from the meal (by being compensated by the magazine publisher or other entity) and may have realized additional revenue (by being paid for access to his customers).

The above example is presented for illustrative purposes only and should not be construed as limiting in any manner. Further embodiments and details of the present invention may be appreciated with reference to the figures below.

Devices

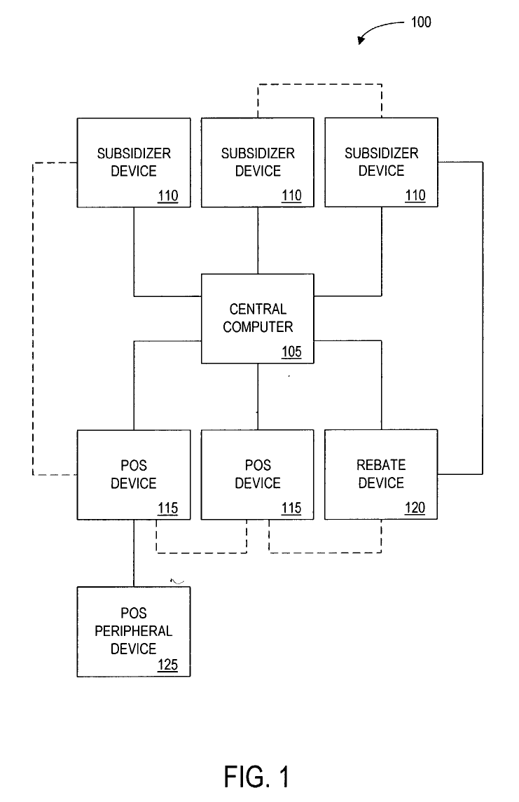

Referring now to FIG. 1, a system 100 according to an embodiment of the present invention includes a central computer 105 that is in communication, via one or more communications networks, with one or more subsidizer devices 110 (e.g., a server computer operated by or on behalf of a subsidizing entity), with one or more point-of-sale (POS) devices 115 and/or with one or more rebate devices 120. The central computer 105 may communicate with the devices 110, 115 and 120 directly, via the Internet, via a wireless medium, via a wired medium such as Ethernet, LAN or WAN or via any appropriate communications means or combination of communications means. Each of the devices 110, 115, and 120 may comprise computers, such as those based on the Intel® Pentium® processor, that are adapted to communicate with the central computer 105. Any number of devices 110, 115, and 120 may be in communication with the central computer 105.

Communication between the devices 110, 115, and 120 and the central computer 105 may be direct or indirect, such as over the Internet through a Web site maintained by central computer 105 on a remote server or over an on-line data network including commercial on-line service providers, bulletin board systems and the like. In yet other embodiments, the devices 110, 115, and 120 may communicate with central computer 105 over RF, cable TV, satellite links and the like.

The communication networks via which the central computer 105 and the devices 110, 115, and 120 communicate may permit or facilitate communication between various devices in communication therewith. For example, (i) the central computer 105 may transmit and/or receive information to/from a POS device 115 (e.g., to control its operation); (ii) the central computer 105 may transmit and/or receive information to/from a subsidizer device 110 (e.g., information about an accepted offer); (iii) the central computer 105 may transmit and/or receive information to/from a rebate device 120 (e.g., information about offers that have been output to customers); (iv) a POS device 115 may transmit and/or receive information to/from a rebate device 120 (e.g., information about a purchase completed by a customer); (v) a POS device 115 may transmit and/or receive information to/from a subsidizer device 110 (e.g., an indication of a benefit that has been provided to a customer); and (vi) a subsidizer device 110 may transmit and/or receive information to/from a rebate device 120 (e.g., information about available subsidies). Additional forms of communication will be readily apparent to those of ordinary skill in the art.

Some, but not all, possible communication networks include: a local area network (LAN), a wide area network (WAN), the Internet, a telephone line, a cable line, a radio channel, an optical communications line, and a satellite communications link. Possible communications protocols include: Ethernet, Bluetooth™, and TCP/IP. Communication may be encrypted to ensure privacy and prevent fraud in any of a variety of ways well known in the art. It should be noted that one set of devices of system 100 may communicate with each other over one type of communications network (e.g., the central computer 105 and the subsidizer devices 110 may communicate over the Internet) while another set of devices of system 100 may communicate with each other over another type of communication network (e.g., the central computer 105 may communicate with the POS devices 115 over a LAN).

Those skilled in the art will understand that devices in communication with each other need not be continually transmitting to each other. On the contrary, such devices need only transmit to each other as necessary, and may actually refrain from exchanging data most of the time. For example, a device in communication with another device via the Internet may not transmit data to the other device for weeks at a time.

The central computer 105 may function as a “Web server” that generates Web pages (documents on the Web that typically include an HTML file and associated graphics and script files) that may be accessed via the Web and allows communication with the central computer 105 in a manner known in the art.

Any or all of the subsidizer devices 110 may comprise, for example, computer servers, conventional personal computers, portable types of computers, such as a laptop computer, a palm-top computer, a hand-held computer, or a Personal Digital Assistant (PDA). Generally, a subsidizer device 110 may comprise any computing device that is operable to communicate with at least central computer 105 in accordance with an embodiment of the present invention. It should be noted that a first subsidizer device 110 may comprise a first type of computing device (e.g., a server computer), while another subsidizer device 110 may comprise a second type of computing device (e.g., a laptop computer). The subsidizer devices 110 may or may not be operable to communicate with one another.

Any or all of the POS devices 115 may comprise, for example, a cash register (e.g., mechanical or electronic). Generally, a POS device 115 may comprise any device operable to facilitate purchases of a customer from a retailer. In embodiments where the retailer is an online retailer, the POS device 115 may comprise a computing device similar to the computing devices described with reference to subsidizer devices 110. Any or all of the POS devices 115 may include a bar code scanner, keypad, and/or any other input device for receiving information related to one or more products being acquired in a purchase. Any or all of the POS devices 115 may also comprise or include means for receiving a previously assigned redemption code or other offer identifier, along with information related to the specific products having been purchased (e.g. coded information such as bar codes, SKUs or other product descriptor(s)).

Further, any or all of the POS devices 115 may include or be in communication with a POS peripheral device 125. A POS peripheral device 125 may be a device that receives information from the POS device 115, such as a coupon printer of the type manufactured by Catalina Marketing Corporation™. A POS peripheral device 125 may be operable to receive information about purchases completed via a POS device 115. One or more such peripheral devices 125 may be in communication with a peripheral device server (not shown), thereby allowing the peripheral device server to receive information regarding a plurality of purchases at a plurality of retailers.

A POS peripheral device 125 may be operable to access a database (e.g., of peripheral server) to issue custom coupons, offers, incentives and messages based upon a purchase being completed at a POS device 115. The peripheral device server may thus monitor customer purchase history over time by associating purchase behavior with customer identifiers, such as loyalty card or check cashing card numbers. Further, this information may be analyzed, e.g., to identify those customers which a particular retailer should find most desirable. Based upon retailer objectives, the peripheral device server may direct the appropriate POS peripheral device 125 to issue customized messages to specific customers that are relevant to their shopping behaviors.

Information received by the POS peripheral device 125 from the POS device 115 may include purchase data such as products purchased, prices of products purchased, coupons redeemed, and time and date of a purchase. The functions described herein as being performed by a peripheral device server may, in other embodiments, be performed be central computer 105 (in lieu of or in conjunction with being performed by a peripheral device server).

Any or all of the rebate terminal devices 120 may comprise, for example, a self-service kiosk, a customer service desk computer (e.g., operated by a customer service representative), a telephone, a vending machine, an automated teller machine (ATM), an output device (e.g., a payment dispensing device), a communication port, and/or a POS device at a second retailer. As an illustration of the last example, a customer may purchase a product at a first retailer, receive a receipt from the first retailer with an offer printed thereon, take the receipt to a second retailer, and accept the offer at the second retailer, thereby receiving the benefit defined by the offer at the second retailer.

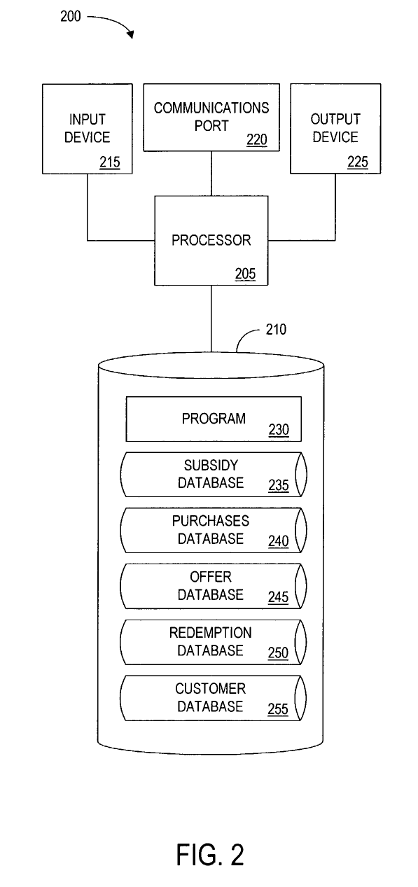

Referring to FIG. 2, an embodiment 200 of the central computer includes a processor 205, memory 210, one or more input devices 215 and one or more output devices 225. In one embodiment, the central computer comprises one or more computers, such as server computers.

An input device 215 may comprise any device via which data may be input to central computer 200. Examples of an input device 215 (and any input device of a computing device described herein) include, but are not limited to, a computer keyboard, a keypad, a computer mouse, a touch screen, a microphone, a video camera, a bar code reader, a magnetic stripe reader, a biometric input device (e.g., a fingerprint reader, retinal scanner), an infra-red port (e.g., for communicating with a customer device), an electronic signature pad, and a voice recognition module. An input device 215 may be operated by a person (e.g., an employee of a retailer and/or subsidizer).

An output device 225 may comprise any device via which information may be output from central computer 200. Examples of an output device 225 (and any output device of a computing device described herein) include, but are not limited to, a video monitor, a liquid crystal display (LCD) screen, a light-emitting diode (LED), a touch screen, an audio speaker, a servo motor, a dot-matrix printer, a thermal printer, and a coin, coupon, or bill dispenser. An output device may output data in a form readable by a human being and/or a computing device.

The memory 210 stores a program 230 for controlling the processor 205. The processor 205 performs instructions of the program 230, and thereby operates in accordance with the present invention, and particularly in accordance with the methods described in detail herein. The program 230 may be stored in a compressed, uncompiled and/or encrypted format. The program 230 furthermore includes program elements that may be necessary, such as an operating system, a database management system and “device drivers” for allowing the processor 205 to interface with computer peripheral devices. Appropriate program elements are known to those skilled in the art, and need not be described in detail herein.

According to an embodiment of the present invention, the instructions of the program may be read into a main memory from another computer-readable medium, such from a ROM to RAM. Execution of sequences of the instructions in program causes processor 205 to perform the process steps described herein. In alternative embodiments, hard-wired circuitry may be used in place of, or in combination with, software instructions for implementation of the processes of the present invention. Thus, embodiments of the present invention are not limited to any specific combination of hardware and software.

The memory 210 also stores a subsidy database 235, a purchases database 240, an offer database 245, a redemption database 250, and a customer database 255. Each of these databases is described in detail herein. Additional databases or configurations of data may be utilized. The databases described herein are provided for illustrative purposes only and describe some of the embodiments of the present invention.

Note that, according to an embodiment, the central computer 200 is operated by one or more retailers who also operate at least one point of sale terminal. However, it is important to note that the central computer 200 may also be operated by another party (in addition to or in lieu of being operated by one or more retailers). For example, the central computer 200 may be operated by a third party that facilitates communication between one or more retailers who participate in the system of the present invention and subsidizers who provide subsidies.

Databases

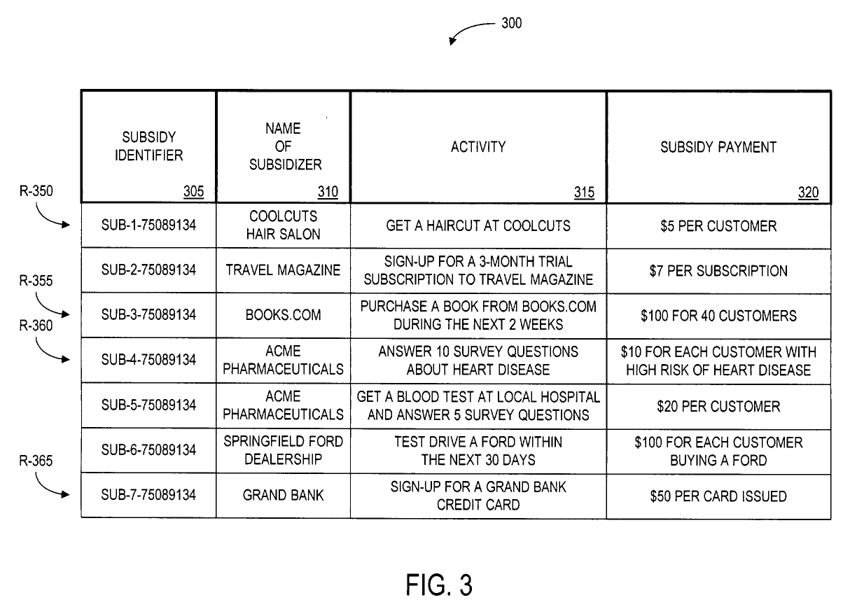

Referring to FIG. 3, a tabular representation 300 of the subsidy database 235 includes a number of example records or entries, including records R-350, R-355, R-360, and R-365. Each of the records defines a subsidy.

Those skilled in the art will understand that the subsidy database may include any number of entries. The tabular representation 300 also defines fields for each of the entries or records. The fields specify: (i) a subsidy identifier 305 that uniquely identifies the subsidy; (ii) a name of a subsidizer 310, that identifies the entity providing the subsidy; (iii) an activity 315 associated with the subsidy; and (iv) a subsidy payment 320, which specifies the amount of the subsidy to be provided and the condition under which it will be provided.

Note that subsidy identifier 305, and all other identifiers described herein, may comprise alphanumeric strings of characters that uniquely identify something, unless otherwise specified. A subsidy identifier, and all other identifiers described herein, may be generated at a time when they are first used or generated beforehand and selected from a list of available identifiers. Further, an identifier may be selected or at least partially determined based on information provided by an entity such as a retailer, subsidizer, customer, another entity, or combination thereof.

Various conditions under which a subsidy payment will be provided may be specified in subsidy payment field 320. For example, record R-350 indicates that a subsidy in the amount of $5 will be provided for each customer that commits to obtaining a haircut at “Coolcuts.”

Record R-355, on the other hand, specifies a different condition under which a subsidy amount will be provided. Record R-355 specifies that a subsidy in the amount of $100 will be provided for every forty (40) customers who commit to a three (3) month trial subscription to “Travel Magazine.” Thus, if only thirty-nine (39) customers commit to this activity, according to record R-355, a subsidy may not be provided.

Record R-360 specifies yet another type of condition under which a subsidy will be provided. Record R-360 specifies that a subsidy in the amount of $10 will be provided for each customer that not only answers ten (10) survey questions about heart disease and who also is determined to have a high risk of heart disease (e.g., based on the customer's answers to the survey questions). Thus, record R-360 illustrates that in some embodiments of the present invention a customer not only has to perform an activity (e.g., answering survey questions) but also otherwise qualify (e.g., having a high risk of heart disease) in order to receive a benefit defined by an offer.

Record R-365 specifies yet another type of condition under which a subsidy will be provided. Specifically, record R-365 specifies that a subsidy in the amount of $50 will be provided for each customer that not only signs up for a “Grand Bank” credit card (e.g., fills out an application for the credit card) but also is approved for the credit card (i.e., the credit card is actually issued to the customer).

It should be noted that the activity associated with a subsidy and/or the conditions under which a subsidy payment will be made may be determined by the subsidizer, the retailer, and/or a combination thereof For example, the activity may be specified by the retailer (and, for example, contingent on an approval by the subsidizer).

According to one embodiment, a subsidizer may provide a subsidy related to a customer's performance of an activity. Such a subsidy may be provided because an activity has value to the subsidizer. For example, a subsidizer may derive value from a customer signing up for a new credit card (the issuing bank may be a subsidizer), viewing an advertisement (the advertiser may be a subsidizer), or getting three friends to register with a website (the website may be a subsidizer).

According to an embodiment, a subsidizer provides a subsidy to the retailer via whom an offer based on the subsidy is provided. Examples of subsidies that may be provided to the retailers include payments (e.g., in money or an alternate currency like frequent flyer miles), products, services, and other forms of consideration. Note that subsidy payments may be monetary and/or non-monetary. Examples of non-monetary subsidy payments include: (i) a food distributor providing free products or product samples to a restaurant; and (ii) a credit card company give a retailer a discount on credit card transaction fees.

Further, subsidy values may be based on a variety of factors, including those used in determining an offer, as described herein.

According to an embodiment, a subsidizer provides a subsidy directly to a customer. In this case, the subsidy provided to the customer may be equivalent to, or in addition to a benefit that is provided to the customer.

According to an embodiment, the central computer may communicate with a subsidizer device to determine information about subsidies. For example, the central computer may negotiate with merchants to develop subsidy offers, develop the language of the offers and associated graphics, and handle back office billing and penalties associated with the offers. In addition, the central computer may store information about subsidizers in a subsidizer database (not shown).

Note that a single subsidy may be provided for multiple activities performed by one or more customers or multiple obligations being committed to by one or more customers (“en mass”). For example, a subsidizer may pay a retailer $10,000 to have customers view 100,000 minutes of advertisements. Lump sum payments may be more convenient for companies with large marketing budgets. A subsidy may be provided at various different times including before, after or substantially simultaneously with an activity performed by a customer.

Note that the value of a subsidy payment may be determined using a mathematical function. For example, a credit card company may provide a subsidy payment of $10 for signing up a customer for a credit card plus 1% of the revenues from the customer's annual purchases.

Subsidy payments may be provided at various times. In one example, a subsidizer may pay $500 at the start of a month in order for a retailer to display advertisements to 20% of its customers. In another example, a subsidizer may pay $603.15 at the end of the month for a retailer having shown 4021 advertisements to customers at $0.15 per advertisement.

Note that subsidy payments may be provided to various parties depending on who operates the central computer and/or who presents offers to customers. In one example, POS devices may be operated by one or more retailers, subsidies may be provided by one or more subsidizers, and the central computer may be operated by a third party (e.g., a clearinghouse system). In this example, subsidy payments may be provided to the operator of the central computer. In another example, portions of a subsidy payment may be provided to more than one entity (e.g., to a retailer and to another entity operating the central computer). In yet another example, the central computer may be operated by a retailer and subsidy payments are provided to the retailer.

In one embodiment, information stored in the subsidy database is received from subsidizers. For example, a subsidizer may use a subsidy device to communicate information about a subsidy to the central computer (which may store or have access to the subsidy database). In a second example, a subsidizer may communicate information about a subsidy to a party operating the central computer, and then the party may enter information about the subsidy into the central computer. In various embodiments of the invention, subsidizers or other parties may add, remove, and modify subsidy agreements that are stored in the subsidy database.

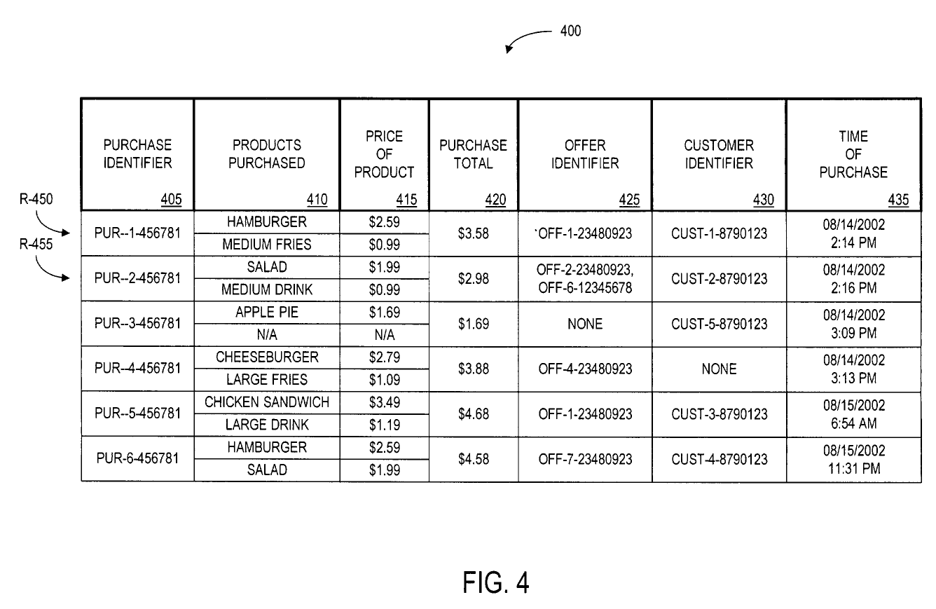

Referring now to FIG. 4, a tabular representation 400 of the purchase database 240 includes a number of example records or entries, including records R-450 and R-455. Each of the records defines a purchase. Those skilled in the art will understand that the purchase database may include any number of entries. The tabular representation 400 also defines fields for each of the entries or records. The fields specify: (i) a purchase identifier 405 that uniquely identifies the purchase; (ii) the products purchased 410, which includes a description of one or more products included in the purchase; (iii) price of the products 415, which identifies the prices of the products described in field 410; (iv) a purchase total, which specifies the amount paid by a customer for the purchase; (v) an offer identifier 425, which identifies the offer (if any) output in association with the purchase; (vi) a customer identifier 430, which identifies the customer who participated in the purchase, and (vii) a time of purchase 435, which indicates the time at which the purchase occurred.

The products purchased field 410 may store an identifier that uniquely identifies one or more products included in a purchase. Such an identifier may be stored in lieu of (or in addition to) a description of the product. In one or more embodiments, the products purchased field 410 may store an indication of a type or category of one or more products included in the purchase rather than a description or identifier of the products themselves. For example, a particular offer may be output to customers who purchase dessert. In such an example, all desserts offered by the retailer may be associated with a particular identifier that identifies the dessert category. In such an example, the products purchased field 410 may store an indication of this identifier that identifies the dessert category. Similarly, the products purchased field 410 may store an indication of some other characteristic of one or more products included in the purchase (e.g., a manufacturer and/or ingredient of a product).

Note that more than one offer may be output to a customer in association with a single purchase. Record R-455, for example, indicates that two (2) offers were output to customer “CUST-2-8790123” during purchase “PUR-2-456781.”

Note that the customer identifier 430 may comprise an alphanumeric set of characters generated or selected specifically for identifying a customer for purposes of the system of the present invention or may be data that serves other purposes as well. As an example of the latter, a customer identifier may comprise a social security number, a driver's license number, a financial account identifier, a biometric identifier, a name, address, and/or telephone number.

Additional information associated with a purchase, such as a POS device identifier that identifies the POS device at which the purchase occurred and/or an employee identifier that identifies the employee who handled the purchase, may also be stored in a purchase database. In embodiments where purchase data for more than one retailer is being stored in a purchase database, the purchase database may further store an identifier that identifies the retailer at which the purchase occurred.

Note that a record in a purchase database such as the one in tabular representation 400 may be opened, for example, for each purchase completed by a customer at a retailer. Alternatively, a record in a purchase database may be opened for each purchase initiated by a customer of a retailer or for each purchase during which an offer was output.

The data in the records of tabular representation 400 may be obtained from communications with one or more POS devices of a retailer. For example, central computer may obtain such data by receiving it from a POS device as a purchase is being completed or after a purchase is completed or by querying a POS device for such information. Such data may be obtained on a periodic basis (e.g., every five (5) minutes in a batch process) or on a non-periodic basis (e.g., as a purchase is completed or an offer output). Note that, in addition to (or in lieu of) such purchase data being stored by the central computer, the data may be stored by one or more POS devices of a retailer and/or one or more rebate devices.

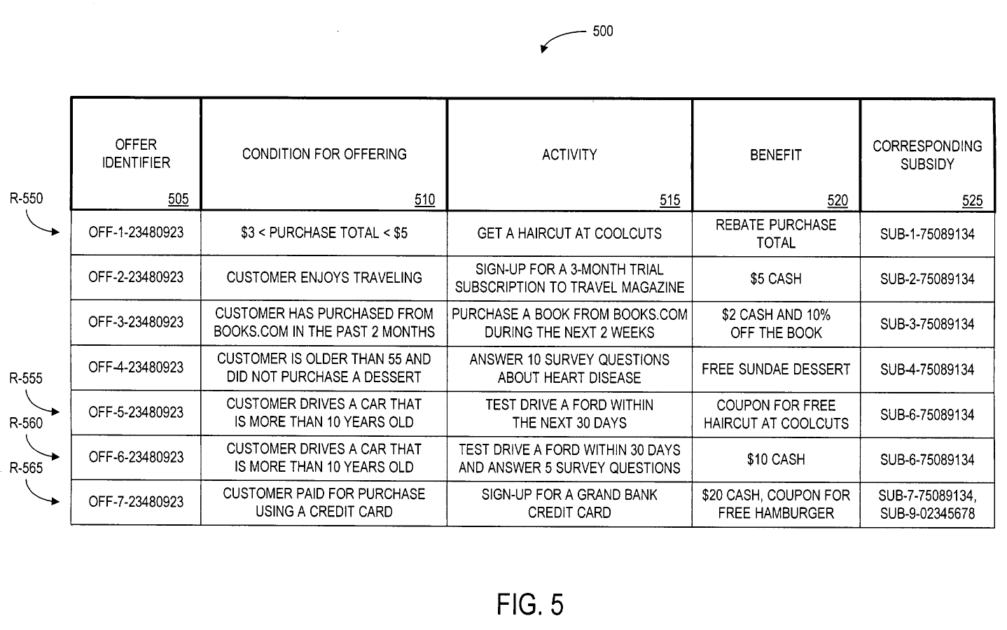

Referring now to FIG. 5, a tabular representation 500 of the offer database 245 includes a number of example records or entries, including records R-550, R-555, R-560, and R-565. Each of the records defines an offer that may be provided to a customer. An offer, as used herein, defines a benefit to be provided to a customer in exchange for the customer's commitment to an activity.

Those skilled in the art will understand that the offer database may include any number of entries. The tabular representation 500 also defines fields for each of the entries or records. The fields specify: (i) an offer identifier 505; (ii) a condition for offering 510, which defines one or more conditions which must be satisfied in order for the offer to be output; (iii) an activity 515, which defines one or more activities the customer accepting the offer must commit to in order to obtain the benefit; (iv) a benefit 520, which defines one or more benefits to be provided to the customer in exchange for the customer's commitment to the activity; and (v) a corresponding subsidy 525 associated with the offer. Note that if an activity field 515 indicates more than one activity associated with an offer, the customer may or may not have to perform each of the activities specified in the record.

According to an embodiment, if a customer performs an activity specified in an offer, then that customer may receive a benefit. According to an embodiment, a benefit provided to a customer may be determined based on the activity performed. For example, the benefit may be based on what activity is performed. For example, a customer may be given a choice of visiting a first Web site and visiting a second Web site. If the customer visits the first Web site, then he earns a return of his full purchase total, up to $10.00. If the customer visits a second Web site, then he earns $3.00.

The benefit may also be based on how an activity is performed. For example, a customer may be given the opportunity to earn $1.00 of his purchase total back for every survey question he answers. If the customer answers twelve survey questions, then he earns $12.00 of his purchase total back. In one or more embodiments a benefit may exceed a purchase total of a purchase the customer participated in when he or she received the offer that defined the benefit. In such embodiments the entire benefit may be provided to the customer at the time of offer acceptance (e.g., as a cash amount). In one or more embodiments where the benefit exceeds the purchase total of the previous purchase, the benefit may comprise an amount of credit with the retailer applicable to future purchases (in which case the retailer benefits by encouraging the customer to return to the retailer in order to take advantage of the credit).

Note that a benefit may be provided to a customer by a variety of different parties, including the central computer (e.g., by crediting a player's financial account); the retailer (e.g., a retailer employee may mail a check); and/or another party (e.g., a subsidizer, a product manufacturer, a service provider). Note also that a benefit may be funded by a variety of different parties (acting together or alone), such as a retailer, a manufacturer, a subsidizer, a marketing company or another appropriate entity. Note further that a benefit may be selected for inclusion in an offer by a variety of different parties. For example, a retailer and/or a subsidizer may select the benefit to be included in a particular offer.

Various different types of benefits may be defined in an offer. A benefit may be any form of consideration, including: (i) money (e.g., cash, or a credit to a financial account); (ii) products (e.g., a meal, a souvenir watch, a sweatshirt, a magazine subscription); (iii) services (e.g., a haircut, an oil change); (iv) discounts on products or services (e.g., 50% off the list price of a hotel room); (v) alternate currencies (e.g., points or frequent flyer miles); (vi) an entry into a game of chance (e.g., a lottery ticket, a free spin on a slot machine); (vii) an entry into a sweepstakes; and/or; (viii) another type of consideration

Money may be provided to a customer in a variety of different ways, including, for example: (i) as a lump sum payment (e.g., a cash amount taken from a POS device cash register drawer and handed to the customer); (ii) as a recurring payment (e.g., $100 a month for the next 3 months); (iii) by crediting a financial account belonging to the customer (e.g., bank account, credit card account, a store account).

According to one embodiment, a benefit may be provided to an entity associated with the customer (e.g., a friend of the customer, a family member, a charity). While providing a benefit to a customer's favorite charity may not provide a tangible benefit to the customer, the customer does receive an intangible benefit (e.g., he may feel altruistic and good-hearted). For this reason, benefits to friends of customers may be particularly motivational for a customer. According to one embodiment, a benefit provided to a friend of a customer may be contingent on the friend performing one or more activities. For example, a customer's friend may be asked to perform an activity in order to receive a benefit.

A customer may receive multiple benefits. For example, a customer may receive multiple benefits for accepting a single offer. A customer may accept multiple offers and thereby receive multiple benefits. A customer may receive a benefit for himself and two additional benefits for two of his friends. A customer may receive multiple benefits for a single offer but at different times. For example, a customer may receive a first benefit when accepting an offer and a second benefit upon completing an activity specified in the offer.

Note that a benefit may be provided to a customer either before or after an activity is performed. For example, a quick service restaurant may provide a customer with a benefit of $5 cash if the customer agrees to test drive a Ford™ sometime in the next two weeks. In another example, a customer may fill out a survey questionnaire and provide it to a retailer; the retailer may then provide the customer with a benefit of a free product (e.g., a free pair of gloves).

Note that if a benefit is provided to a customer before an activity is performed, then some customers might attempt to cheat the system by accepting an offer, receiving a benefit, and then not performing an activity specified in the offer. One way of avoiding this is to penalize a customer if he does not perform an activity as promised. Various methods of penalizing a customer who does not perform an activity or otherwise fulfill an obligation the customer committed to are described herein.

Note that a benefit may be defined but not particularly specified in the offer that is output to a customer. For example, an offer may define a benefit by stating that a customer may “get 50% of his purchase total back, up to $10.00” by committing to an activity, without actually stating the exact dollar amount that the customer is to receive as the benefit upon committing to the activity. Defining a benefit without particularly specifying the benefit may be utilized in embodiments where offers are pre-printed or otherwise not customized for particular purchases.

In other embodiments, an offer may specify the particular benefit that is to be provided to the customer once the customer commits to the activity defined by the offer. Such embodiments may comprise specifying a benefit that is customized for the particular customer or specifying a benefit based on a characteristic of the purchase the customer participated in when the offer was output. For example, the offer may specify that the customer is to receive a benefit comprising $4.89 (e.g., the purchase total of the purchase the customer was participating in when the offer was output to the customer). In this example, the offer is most probably printed specifically for the customer participating in the purchase at the time of the purchase (since it is unlikely that the retailer would have an offer pre-printed with such an exact dollar amount specified as a benefit).

In another example, the offer may specify that the customer is to receive “the price of the Happy Meal™ back” if the customer commits to the activity. In the latter example, although an exact dollar amount is not specified as the benefit, the description of the benefit is still customized based on a characteristic of the purchase (e.g., because it specifies a product included in the purchase). In this latter example, the offer may or may not have been printed specifically for this customer or at the time of the purchase. For example, the retailer may have offers pre-printed that specify particular products and/or services sold by the retailer within the description of the benefit and simply provide an offer that includes the description of a particular product or service to those customers that purchased the particular product or service).

Referring to the activity field 515, it is noted that in order to earn a benefit defined by an offer, a customer may perform an activity. Examples of activities include signing up for a new credit card and answering survey questions about a product or service. In many cases, an activity has value to a subsidizer. For example, a credit card issuer may be willing to pay up to $50 to get a customer to sign up for a new credit card, since acquiring this customer will likely result in more than $50 of revenues for the credit card issuer.

Activities may be grouped into some exemplary categories, such as: (i) purchasing a product or service; (ii) using a product or service; (iii) selling a product or service; (iv) providing a product or service; (v) providing information; (vi) viewing information; and (vii) performing an action. There are many other types of activities and some activities do not fit clearly into any one category.

Examples of activities that comprise purchasing a product or service include: (i) signing up for a magazine subscription; (ii) buying a product from a retailer other than the retailer at which the offer was output; and (iii) purchasing an additional product from the same retailer at which the offer was output.

Examples of activities that comprise using a product or service include: (i) receiving a new credit card; (ii) using a new long distance telephone provider; (iii) printing at least 100 pages per week from an HP™ laser printer; and (iv) agreeing to receive a free trial subscription to a magazine or service.

Examples of activities that comprise providing a product or service include: (i) providing legal, medical, or another type of advice; and (ii) donating an items such as an old television set.

Examples of activities that comprise selling a product or service include: (i) selling a used product (e.g., on the eBay™ Web site or another auction or classifieds Web site); and (ii) providing tax or another type of advice at a rate (e.g., $10 per hour).

Examples of activities that comprise providing information include: (i) answering survey questions; (ii) providing product ratings and reviews; and (iii) indicating demographic information, purchasing information or giving permission to access such information.

Examples of activities that comprise viewing information include: (i) watching a television commercial or other advertisement; (ii) listening to an audio tape that conveys a specified message (e.g., about the health dangers of smoking cigarettes); and (iii) reading a pamphlet that explains how to use a product.

An example of an activity that comprises performing an action is playing a game of chance or a game of skill. For example, a customer may perform an activity of spinning the reels on a slot machine. The customer may then win a pricing benefit based on the outcome of the spinning reels. Other examples of activities that comprise performing an action include: (i) applying for a credit card; and (ii) performing a customer-segmenting activity (i.e., an activity that allows a seller to segment its customer base). As an example of the latter type of activity, a seller may segment its customer base by asking customer to perform an activity over an extended period of time (since some customers will not have the time to perform such activities).

There may be limitations, conditions, or other restrictions relating to a customer's performance of an activity. For example, an activity may include a time-based requirement. For example, a requirement associated with an activity may specify that (i) an activity must be started before a designated time or event (e.g., before the end of a baseball game); (ii) an activity must be started after a designated time or event (e.g., after eating dinner); (iii) an activity must be finished by a designated time or event (e.g., before 6 pm tonight); (iv) an activity must take place during a designated time period (e.g., between 4 am and 8 am); and/or (v) an activity must be performed before a designated occurrence or condition (e.g., before the end of a sale, before the customer visits the retail store again). Record R-555 specifies a time-based requirement on the activity defined by the offer (the customer must test drive a Ford™ within the next 30 days).

An offer may require that a customer perform multiple activities in order to receive a benefit. These activities may be performed sequentially, simultaneously, or in some other fashion. For example, a customer may have to answer survey questions online (a first activity) and purchase a product from a specified online retailer (a second activity). Record R-560 defines an offer that specifies two activities.

In accordance with one embodiment, a customer may have to perform a repeated activity (e.g., purchasing a product from a retailer at least once a month for duration of an insurance policy; maintaining a balance on a credit card). In such an embodiment, the customer may receive a benefit or portion of a benefit before completing any instance of the activity, a benefit or portion of a benefit each time the customer completes an instance of the activity, and/or a benefit or portion of a benefit once the customer successfully completes the last required instance of the activity.

According to one embodiment, a customer's completion of an activity may be determined based on activities of other customers. For example, a customer may perform a competitive activity (i.e., an activity where success is determined relative to at least one other customer). In such an embodiment, a customer may have to win a game or be one of the first ten customers to collect receipts from all restaurants in an area. As another example, a customer may perform a team activity (i.e., an activity where customers work together to accomplish a common goal). For example, all the customers at a fast food restaurant may have to work together to consume 100 hamburgers in the next hour.

According to one embodiment, the customer may have to perform one of a plurality of activities. In embodiments where a customer may have to perform one of a plurality of activities, the customer may have a choice of what activity to perform. For example a customer may required to either test drive a Ford™ Mustang™ or buy a ticket to a boxing match. If the customer performs either activity, then this will satisfy the requirements of his offer. In one embodiment the customer may be required to select which activity to perform at a time the customer accepts the offer defining the activity. In another embodiment, the customer may indicate his selection of the activity by performing one of the available activities (i.e., the customer's selection will be inferred based on which activity the customer performs).

In one embodiment, there may be restrictions as to the time, manner, and place for performing an activity or fulfilling an obligation defined by an offer. For example, a requirement associated with an activity may specify that (i) the activity must be performed while a customer is at a retailer, and/or (ii) the activity must be completed in a satisfactory manner. In the latter example, the offer output to the customer that defines the activity may specify what constitutes a satisfactory manner.

According to an embodiment, it may be permissible for an activity to have been performed in the past. For example, a customer may be asked to perform an activity of purchasing a product. If the customer has already purchased the product (i.e., in the past), then this may constitute performance of the activity. In an embodiment, there may be limitations as to the acceptability an activity performed in the past. For example, an activity that occurred more than three (3) months ago may not be acceptable. Note that a customer may be asked to provide evidence that he performed an activity in the past (e.g., providing a receipt or his frequent shopper card).

In an embodiment, a customer may provide an activity code to authenticate his performance of an activity. For example, a customer may have performed an activity in the past. Based on the customer's performance of this activity, an activity code may be indicated to the customer. This activity code might be, for example, a 10-digit number on a receipt, or a series of bits on a magnetic stripe card that serves as proof that the customer did indeed perform the activity. The customer may later use the activity code to indicate his performance of the activity. According to one embodiment, activity codes may be produced using a cryptographic protocol to avoid tampering and cheating by customers.

According to an embodiment, it maybe permissible for a customer to make a forward commitment to perform an activity. According to one embodiment, a forward commitment is an agreement to perform an activity at some point in the future. For example, a customer may be required to perform an activity of test driving a Ford™ Escort™. The customer may agree to perform this activity later (e.g., once he returns home from visiting the retailer). Based on this commitment, an immediate benefit may be provided to the customer. Note that forward commitments may include time-based requirements and expiration conditions.

According to an embodiment, a forward commitment may be penalty-secured. This means that a customer may be penalized for not completing the activity specified in the forward commitment. For example, a customer's credit card may be charged $100 or the value of the benefit previously provided if he does not complete an activity by a specified date. Examples of penalties include monetary penalties that may be charged to a customer's credit card, debit card, customer account or other financial account.

According to one embodiment, a customer may be required to provide a payment identifier (e.g., a credit card number) when signing up for a penalty-secured forward commitment. Another example of a penalty is a denial of products or services (e.g., the customer may not be permitted to accept additional offers or shop at the retailer any more). Penalties that involve denial of products or services may be temporary. For example, a penalty may expire after two months, after the customer performs an additional activity, or when some other condition is true. Other examples of penalties include (i) requiring the customer to perform one or more additional activities, (ii) publishing the customer's name along with an indication that he or she failed to perform an activity as promised, and/or (iii) requiring the customer to provide another form of consideration.

Note that penalty-securing a forward commitment may be necessary to avoid a number of different methods of cheating the system. For example, if a forward commitment was not penalty-secured, then a customer may promise to perform an activity, receive a benefit, and never perform the activity as promised.

Penalties may be imposed at various different times or enacted against friends of a customer. The central computer, subsidizer device, or another computing device may determine a penalty. The penalty may be specified to the customer as part of the offer that is output to the customer.

In one embodiment, a customer who accepts an offer to perform an activity also performs the activity and receives a benefit. However, activities may be performed by a variety of different parties, including: (i) a party that receives/accepts an offer; (ii) a party that receives a benefit; (iii) a party that participates in a purchase; and/or (iv) at least one other party (e.g. a friend of a customer who accepts an offer).

Note that a customer who performs an activity may be different from a party who accepts an offer to perform an activity. For example, a customer may accept an offer that gives him a discount if one of his friends performs an activity.

Note that a customer who performs an activity may be different from a party who receives a benefit. For example, a mother may perform an activity that provides a benefit of a discount on video games to her adolescent son.

In addition, note that an entity who performs an activity may be different from both a first entity who receives and accepts an offer and a second entity who receives a benefit. For example, a woman may accept an offer that requires her husband answer survey questions and provides a discount on video games for her son. In other words, in accordance with some embodiments, “the customer” described herein may be one or more entities, and not all entities need to participate in every step of the methods of the present invention.

An activity may be performed by one or more entities. Examples of entities include a customer, friends of a customer, other customers, and other entities that interact with a customer who accepts an offer to perform an activity. For example, a customer may agree to an offer that requires ten (10) of his friends to perform an activity of subscribing to a specified Internet Service Provider (ISP).

According to one embodiment, a customer may receive help in performing an activity. For example, one or more other entities may perform an activity in the place of the activity being performed by the customer or in addition to the activity being performed by the customer. For example, a customer may be required to perform an activity of playing a slot machine continuously for four (4) hours. The customer may enlist three (3) friends to help him perform this activity (e.g., each person plays the slot machine for one (1) hour, and then gives up his seat to the next person). In another example, a customer may be required to perform an activity of signing up for three (3) magazine subscriptions. If the customer is only interested in receiving two (2) magazines, the customer may be allowed to fulfill his obligation to the remaining third subscription by convincing a friend to sign up for the third subscription. In yet another example of how a customer may fulfill an obligation with the help of another entity, a customer may be required to perform an activity of completing a Tae-Bo™ workout. If customer does not enjoy Tae-Bo™ but knows another person who does, the customer may be allowed to fulfill his obligation by convincing this other person to perform the workout. Alternatively, it may not be permissible for a customer to receive help in performing an activity.

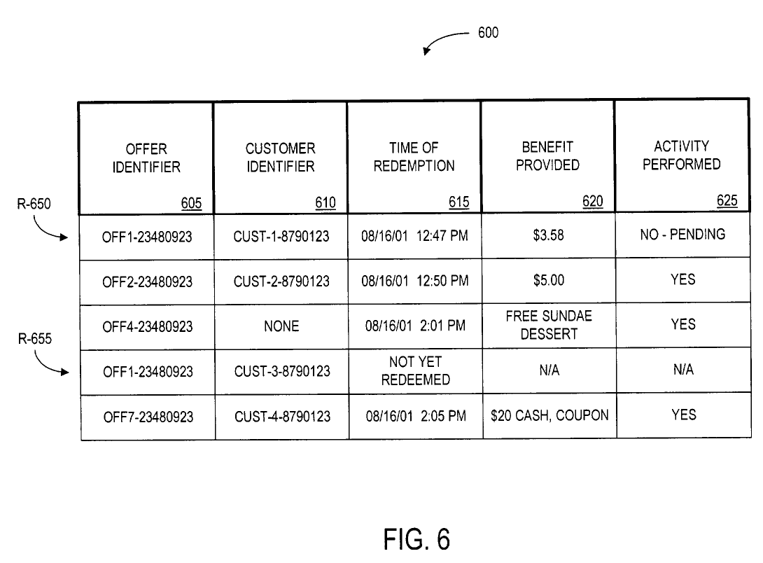

Referring now to FIG. 6, a tabular representation 600 of the redemption database 250 includes a number of example records or entries, including records R-650 and R-655. Each of the records defines an offer that has been provided to a customer and indicates whether the offer has been redeemed.

Those skilled in the art will understand that the redemption database may include any number of entries. The tabular representation 600 also defines fields for each of the entries or records. The fields specify: (i) an offer identifier 605 that identifies an offer that was output to a customer; (ii) a customer identifier 610 that identifies the customer to whom the offer was output; (iii) a time of redemption 615 that indicates the time at which the offer was redeemed or an indication that the offer was not yet redeemed; (iv) a benefit provided 620 that indicates the one or more benefits that were provided to the customer who redeemed the offer; and (v) an activity performed 625 which indicates whether the one or more activities associated with the offer were performed.

Note that, the offer identifier 605 may correspond to an offer identifier 505 of the embodiment of the offer database in tabular representation 500. Similarly, one or more of the customer identifiers in field 610 may correspond to one or more of the customer identifiers in field 430 of the purchase database.

For example, record R-650 indicates that offer “OFF1-23480923” was output to a customer identified as “CUST-1-8790123”, that the customer had redeemed the offer on Aug. 16, 2001 at 13:47, had been provided with the benefit of $3.58, but had not yet performed the activity associated with the offer. Referring to FIG. 5., record R-550 indicates that the offer identified as “OFF1-23480923” provides a benefit of a rebate for the entire cost of the transaction and that the activity to be performed is a haircut at a business called “Coolcuts”. Referring to FIG. 4, record R-450 indicates that the customer identified as “CUST-1-8790123” participated in the purchase identified as “PUR-1-456781”, wherein the purchase total of the purchase was “$3.58”. Referring again to record R-550 of FIG. 5, this purchase total met the conditions for offering of the offer identified as “OFF-1-23480923” (the purchase total being greater than $3.00 but less than $5.00) so the offer was output to the customer. The customer subsequently accepted the offer and received his money back from the previous purchase (the benefit of $3.58). The customer obtained the benefit upon redeeming the offer. Upon redeeming the offer the customer committed to obtaining a haircut at “Coolcuts” but the customer has not yet fulfilled this commitment.

Note that, although offer “OFF-1-23480923” does not specify a time by which the activity defined by the offer has to be performed, other offers do so. For example, referring again to FIG. 5, record R-555 defines an offer “OFF-5-23480923” that specifies an activity has to be performed within thirty (30) days. This thirty (30) days may be measured from, for example, the time the offer was redeemed, the time the offer was output, or another specified time.

Note that, as used herein, redeeming an offer comprises accepting an offer, unless expressly indicated otherwise. For example, when a customer redeems an offer that was output to him or her, the customer is accepting the offer and thus committing to the one or more activities defined by the offer. The customer is also provided with the one or more benefits defined by the offer.

Note that, in some embodiments, the customer performs an activity defined by an offer at substantially the same time the customer accepts the offer. For example, an activity defined by an offer may be answering a survey, wherein the survey form is printed on a form that is provided to the customer along with the offer. In this example, the customer may fill out the survey and provide it along with the offer identifier when accepting the offer. In another example, an activity defined by an offer may comprise signing up for a service such as a subscription to a magazine. In this example, the customer may provide a payment identifier (e.g., a credit card account number) when accepting the offer and the credit card may be charged for a cost associated with the service or the service provider may be notified of the customer's agreement to sign up for the service at substantially the time the customer is accepting the offer. The customer, in this example, is thus committed to the activity and performs the activity at the time the customer accepts the offer.

Additional information related to the redemption of an offer may be stored in the redemption database. For example, a time at which the offer was output to a customer and/or a time at which the customer performed the one or more activities defined by the offer may be stored. In embodiments wherein the offer defines more than one activity and the customer selects the activity the customer commits to, the redemption database may store an indication of which activity the customer committed to.

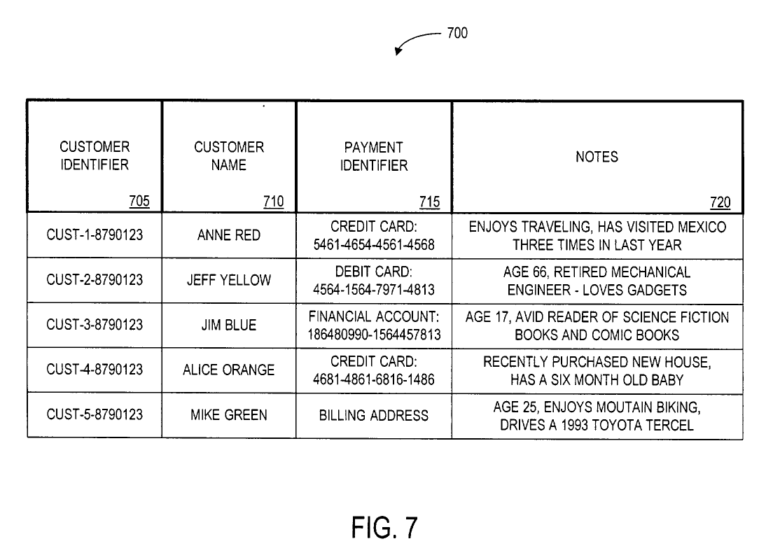

Referring now to FIG. 7, a tabular representation 700 of the customer database 255 includes a number of example records or entries. Each of the records defines an offer that has been provided to a customer and indicates whether the offer has been redeemed. Those skilled in the art will understand that the redemption database may include any number of entries.

The tabular representation 700 also defines fields for each of the entries or records. The fields specify: (i) a customer identifier 705; (ii) a customer name 710; (iii) a payment identifier 715; and (iv) notes 720. The customer identifier 705 may correspond to the customer identifier 430 and/or the customer identifier 610. In some embodiments the customer identifier 705 and the customer name 710 may comprise the same information and a single field may be used to store that information. In some embodiments the customer identifier 705 and the payment identifier 715 may comprise the same information and a single field may be used to store that information.

A record in the redemption database may be opened when an offer is output to a customer (e.g., based on the offer identifier). Subsequently, when the customer redeems the offer, the customer identifier may be determined (e.g., generated or obtained from the customer), and the time of redemption may be stored along with an indication of the one or more benefits provided to the customer at the time of the redemption. Alternatively, a record in the redemption database may be opened when an offer is redeemed or accepted by a customer.

The notes field 720 may store an indication of a characteristic of a customer or other data associated with a customer. The information stored in field 720 may be utilized in determining which offer to present to a customer, whether a particular subsidizer would be interested in acquiring a particular customer, and/or what activity or benefit to include in an offer to be presented to the customer. The information stored in notes field 720 may be acquired, for example, via a survey answered by the customer. Alternatively, an employee of a retailer utilizing the customer database may enter information into the notes field 720 for a particular customer as the employee learns information about the customer (e.g., through conversations or other interactions with the customer). In one embodiment, the information in notes field 720 may be purchased from outsider sources (e.g., from mailing list services) and/or obtained from public records.

Methods

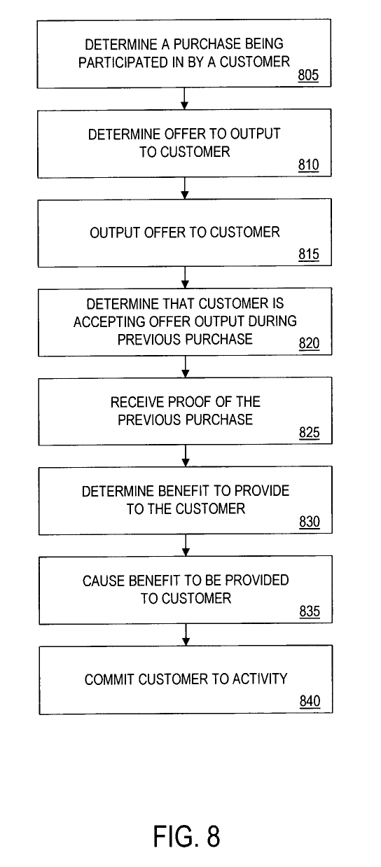

Referring now to FIG. 8, a process 800 illustrates a method for facilitating the provision of a benefit to a customer in exchange for the customer's commitment to an activity, consistent with an embodiment of the present invention. As used herein, the phrases “in an embodiment” and “in one embodiment” are used to indicated “in one or more embodiments”, unless expressly indicated otherwise. The process 800 is presented for illustrative purposes only and is not meant to be limiting in any manner. The steps of process 800 may be performed in an order other than that presented in FIG. 8. Steps of process 800 may be performed by the central computer, a POS device, a controller of a POS device, a POS peripheral device, a rebate device, a subsidizer device, another computing device, or a combination thereof.

In step 805, a purchase being participated in by a customer of a retailer is determined. This step may comprise, for example, determining that a new purchase has been initiated at a POS device, that a product or service has been rung up at a POS device, that a purchase total has been determined at a POS device, or that payment for a purchase has been received from a customer. Note that a purchase need not be completed (i.e., a customer need not have provided payment in exchange for goods or services) in step 805. For example, step 805 may comprise determining that a customer has expressed interest in purchasing a product and/or service (e.g., by selecting the product and/or service from a display or menu). In an embodiment where the retailer comprises a restaurant in which customer order food items on an ongoing basis during their visit and pay the bill at the end of the visit, step 805 may comprise determining that a customer has sat down at a table of the restaurant, a waitperson has started an open check for a customer, and/or that the customer has placed an order for a food item.

In step 810 an offer for output to the customer who is participating in the purchase is determined. Such an offer may comprise an activity for the customer to perform, and a corresponding benefit to the customer in exchange for the performance or promise to perform the activity (or commitment to an obligation). For example, the offer may be to receive a refund of the amount of the purchase total from the purchase in exchange for applying for a new credit card account.

Examples of offers include:

(i) “If you sign up for a 3-month trial subscription to Family Circle™ magazine, then we'll refund the cost of the two happy meals you just purchased.”In this example the activity is signing up for a magazine subscription and the benefit is a refund cost of happy meals.

(ii) For a customer who purchased a meal with a medium drink: “If you answer these 10 survey questions, then we'll give you a free refill of your medium drink.”In this example the activity is answering survey questions and the benefit is a free refill.

(iii) For a customer who is a frequent shopper at the Acme supermarket: “If you sign up for an Acme credit card, then we'll give you 5% off of this transaction and all your purchases in the next two weeks.” In this example the activity is signing up for credit card and the benefit is 5% off.

(iv) For a customer who purchased a meal with a salad: “If you buy a hot fudge sundae dessert, then we'll give you a free ticket to Nick's Comedy Club.” In this example, the activity is buying a hot fudge sundae and the benefit is refunding the cost of the salad.

Note that in examples (i) and (ii) above, the offer as it is output to a customer is customized for the particular customer to whom it is output, in that it refers to a particular product that was included in the customer's purchase. As described above, such a customized offer may be printed for the customer at the time of the customer's purchase or may be pre-printed and selected because it refers to a product included in the customer's purchase. Note that example (iii) above is an example of a generic offer that may be output to any customer (e.g., if the conditions, if any, for outputting the offer are met) because it does not describe a benefit with reference to a particular characteristic of a purchase.

According to one embodiment, the central computer determines an activity and a benefit using a rules-based system. For example, the central computer may store an offer database like the one shown in FIG. 5, which stores a condition for outputting each offer. Whenever a condition in the offer database is true, the central computer will select the corresponding offer to be made to the customer. This offer may then be output in an appropriate way (e.g., printing it on the customer's receipt). An offer may be customized before being output to a customer by text that is selected based on the purchase during which it is being output.

There are many other ways of determining an activity to be performed and a benefit to be provided. In one example, an activity and/or benefit are selected based on a pseudo-random system. For example, a central computer may randomly select an activity for the customer to perform from a list of potential activities (e.g., in a database) and also select a benefit from a list of potential benefits (e.g., in a database). In another example, a customer may be allowed to choose his own offer from a selection of available offers. In yet another example, a customer may be allowed to choose an activity to perform from a list of potential activities. The list of potential activities may be determined by the central computer and displayed to an operator of a POS device. The operator may then present the list of potential activities to the customer. In yet another example, an operator of a POS device may be allowed to choose an offer for the customer. In some embodiments, an activity may be determined using a first method and a benefit may be determined using a second method. For example, an activity may be determined based on what condition for outputting an offer is satisfied, whereas a benefit may be determined using a pseudo-random process.

If the central computer uses conditions and corresponding offers to determine an activity and a benefit to present to a customer, then the central computer may evaluate one or more types of data in determining whether the condition is true. Some general types of data include, but are not limited to (i) data relating to the condition(s) that must be satisfied in order for a particular offer to be output, as described herein; (ii) characteristics of the player; (iii) characteristics of the operator of a POS device or other person who will present the offer; (iv) the customer's purchasing activities; (v) data relating to the customer's visit to the retailer; (vi) data relating to other customers; (vii) the retailer's revenues; (viii) data relating to subsidies; and/or (ix) data relating to offers. Any or all of this information may be made available to the operator of a POS device, which may assist the operator in providing offers or providing offers more effectively.

Examples of factors relating to a customer's purchasing history include: (i) which products the customer has purchased (e.g., in which combinations); (ii) when the customer shops (e.g., daytime, nighttime, alternate Tuesdays); (iii) returns, complaints, or other customer service requests by the customer; (iv) what form of payment the customer uses (e.g., cash, credit card, check); and (v) trends that may be useful in predicting future purchases. According to one embodiment, information about a customer's purchasing history is stored in the customer database.

Examples of factors relating to the current purchase include: (i) products purchased by the customer; (ii) the purchase total; (iii) payment provided by the customer (e.g., amount and or type); and (iv) change provided/due to the customer. Information regarding such factors may be communicated, for example, from a POS device at which the customer is participating in the purchase to the central computer.

Information about a customer's characteristics may allow the central computer to select offers that are particularly appealing to the customer. Examples of customer characteristics include: (i) the customer's hobbies and interests (e.g., sailing, golf); (ii) physical characteristics of the customer (e.g., age, height, weight, nationality, gender, dress and appearance); (iii) psychological characteristics of the customer (e.g., creativity, risk-aversion); (iv) the customer's marital status; (v) the customer's occupation, income, work hours, credit report, home town; (vi) the customer's medical history; and (vii) information related to friends of the customer (e.g., the identity of one or more friends of the customer). According to one embodiment, information about customer characteristics is stored in the customer database (e.g., in the notes field 720 of tabular representation 700).

In one example of a factor relating to the retailer's revenue include, a quick-service restaurant may attempt to avoid selling food before it becomes stale and needs to be thrown out (e.g., in order to maximize revenues and minimize waste). Therefore the quick-service restaurant may select offers that sell food to customers before it becomes stale.

In another example of a factor relating to the retailer's revenue, a movie rental store (e.g., Blockbuster Video™) may attempt to rent as many tapes as possible each night, since an unrented tape on the shelf generates no revenue and late fees average $0.45 per movie rental. Therefore, the movie rental store may offer free rentals as a benefit to customers.

In yet another example of a factor relating to the retailer's revenue, a jazz club may attempt to sell out every performance since this generates additional sales, improves the atmosphere of the club, creates new jazz aficionados, and thus maximizes revenue. Therefore the jazz club may select offers that define attending jazz performances as an activity.

According to one embodiment, the central computer may include a product database that stores information about the costs of products. Such information may be utilized as a factor related to the retailer's revenue. For example, products with a low cost to the retailer may be selected as a benefit and/or products with a high margin may be selected as a future purchase that is an activity the customer must commit to when accepting the offer.

An example of a factor relating to subsidies is available subsidies provided by a subsidizer. For instance, a credit card company may pay a retailer $50 if a customer performs an activity of signing up for a new credit card. Similarly, a magazine publisher may give a retailer an 80% discount on magazines that are provided as benefits to customers.

Another example of a factor relating to subsidies is information provided by a subsidizer. For example, a subsidizer may request that a customer perform a particular activity in exchange for the subsidizer providing the subsidy.

Examples of factors relating to offers include: (i) whether the customer completes an activity specified by a previous offer; (ii) the inventory of offers (e.g., in an embodiment where only a limited number of offers may be presented); (iii) offers that have already been made to the customer; (iv) offers that the customer has accepted or rejected (e.g., as stored in the redemption database shown in FIG. 6); (v) offers that have been made to other customers (e.g., as stored in the redemption database shown in FIG. 6); and (vi) the activity to be performed by the customer (e.g., the benefit may not be determined until after the customer completes the activity). According to this last example, the benefit may be based on how well the customer performs the activity. Another example of a factor relating to offers is the benefit to be provided in an offer (e.g., the customer may be allowed to select what benefit he would like to earn, wherein, based on this benefit, the controller may determine what activity the customer should perform to earn this benefit). Yet another example of a factor relating to offers is whether the customer is suitable for a particular type of offer (e.g., if the offer is for a new credit card, what is the customer's credit limit? If the offer is for a magazine subscription, does the customer already receive the magazine?).

Yet other examples of a factors relating to offers include (i) factors that affect performing an activity (e.g., if the noise level in a store is very loud, then the controller may select an activity that does not require the customer to hear anything); (ii) factors that affect the value of an activity (e.g., information about customer buying habits may be more valuable two weeks before a big sale than the day after a big sale); (iii) activities in progress (e.g., only one customer at a time may be able to view a particular advertisement); and (iv) anticipated future activities (e.g., other customers waiting in line to perform activities).

In one example of an indication by the customer that may affect determining an offer, the customer may be allowed to choose his own offer (e.g., by selecting an activity from a list of activities and a benefit from a list of benefits). In another example of an indication by the customer that may affect determining an offer, an offer provided to a customer may be determined based on the result of a game played by the customer. If the customer performs well in the game, then he may receive a better offer. For example, the customer may scratch-off panels on a ticket or coupon to reveal portions of an offer.

In one example of indications from other parties on which a determination of an offer may be based, an indication may be received from an employee of a retailer. For example, a cashier who takes a customer's order may indicate what offer the customer should get. Through their interactions with customers, employees may be better able to determine which offers should be presented to customers. In one embodiment, employees may receive compensation for selecting offers that are later accepted by customers.

In another example of indications from other parties on which determination of an offer may be based, an indication may be received from other customers. For example, a friend of a customer may indicate what type of offer would be most appropriate for the customer.

In yet another example of indications from other parties on which determination of an offer may be based, an indication may be received from a subsidizer. In addition to providing subsidies, subsidizers may also provide other information useful in determining an offer to present to a customer (e.g., demographic information).

According to one embodiment, an offer as output to a customer may not specify a benefit specifically but may simply define the benefit. The benefit may then be determined based on the activity performed.

Note that an offer may not be determined for every customer at a retailer. Accordingly, step 810 may include a determination of whether an offer should be output to the customer. For some customers, the central computer may determine not to output an offer to the customer. Examples of reasons for a determination not to output an offer to the customer include: (i) determining that a customer has already received an offer in the past and a desire to avoid making duplicate offers; (ii) determining that a customer is be banned from receiving offers (e.g., because he did not perform an activity as required in a previous offer accepted by the customer); (iii) determining that traffic at the retailer is very busy and outputting an offer to a customer would slow down the transaction rate at the point of sale terminal.

Note that if offers are output less often, then at least some customers may view them as being more attractive, special, or valuable. This may in turn result in customers paying more attention to offers and/or accepting more offers. Accordingly, a determination not to output an offer may also be random or based on how many other offers have been output within a predetermined amount of time (e.g., offers are output in only every three (3) out of seven (7) transactions).

Step 810 may comprise retrieving an offer from an offer database (e.g., a database which stores offers available for output to customers, such as the one illustrated by tabular representation 500). For example, one or more offers may be stored in the memory of a device as available for output to customers. Further, at least one of the offers may be associated with at least one condition that must be satisfied before the offer is output. For example, the purchase being participated in by a customer may need to include a predetermined characteristic (e.g., include a particular product or type of product or be of a predetermined purchase total). In another example, the customer participating in the purchase may need to satisfy a predetermined characteristic (e.g., fit a predetermined demographic profile).

In one embodiment, the step 810 of determining an offer may comprise creating an offer by determining an available subsidy and/or pairing a benefit with an activity. Determining a subsidy may comprise determining a subsidy available from a subsidizer. A subsidy, as used herein, is a payment or other consideration provided by an entity in exchange for a customer performing an activity. As used herein, an entity that provides a subsidy is a subsidizer (also referred to as a subsidizing entity herein). A subsidizer may be, for example, a business that provides a payment to a retailer in exchange for the retailer's obtainment of a customer's commitment to an activity. According to an embodiment, a subsidizer may provide a subsidy to an offer recipient (e.g., a customer) and/or to the retailer or other offering party. For example, a subsidizer that is a bank may find it advantageous to require the customer to perform an activity such as signing up for a credit card issued by that bank.

Note that a benefit provided to a customer may be different from a subsidy payment provided to a retailer. Benefits are meant to motivate customers to perform activities, whereas subsidy payments are meant to compensate the retailer for making offers to customers. What is motivational for a customer may be very different from what is appropriate compensation for retailer. According to one embodiment, benefits are provided to a customer by a retailer while subsidies are provided by a subsidizer to the retailer. Note that the method of the invention does not preclude a subsidizer from offering a benefit to a customer in addition to providing a subsidy payment to a retailer.

In one embodiment, a retailer who outputs offers to customers may profit from the difference between the value of a subsidy payment provided by a subsidizer and the value of a benefit provided to a customer. For example, a retailer may receive a subsidy payment of $5.00 from a subsidizer and provide a customer with a benefit of a children's toy worth $3.00. The retailer may keep the $2.00 difference as profit. In one embodiment, a service provider involved in the provision of an offer to a customer may also obtain a portion of a subsidy provided by a subsidizer. For example, a service provider may receive a subsidy payment of $5.00 from a subsidizer and provide $4.50 of this subsidy payment to a retailer. The retailer may then provide a benefit of $4.00 to a customer based on this subsidy payment. In this example, the service provider and the retailer each obtain $0.50 of the subsidy payment.

A subsidizer may not have the ability to provide a particular type of benefit to a customer. Similarly, a retailer may have the ability to provide particularly appealing benefits to a customer. For example, a subsidizer may be a credit card company and the retailer that outputs offers to customers may be a quick service restaurant chain. While it would be easy and appropriate for the quick service restaurant chain to provide a benefit of a free meal to a customer, it may be more difficult for the credit card company to provide this benefit. Instead, the credit card company could provide a subsidy payment of money to the retailer (e.g., as compensation for the retailer's provision of the free meal to the customer).

In step 815, the offer that was determined in step 810 is output to the customer who is participating in the purchase. An offer may be output in a variety of manners. For example, an offer may be output in visual and/or audio form.

If an offer is output in visual form it may be printed or displayed to a customer. For example, the offer may be printed on a paper substrate such as the receipt for the purchase, a paper placemat provided to the customer as a liner for a tray, a food container in which a food product the customer ordered is to be placed, and/or on a coupon or other document to be provided to the customer. Alternatively, a sign or screen (e.g., a screen of a POS device or a POS peripheral device) may display the offer to the customer. For example, if the customer is a customer in a car ordering food at a drive-thru station of a quick service restaurant, the offer may be displayed to the customer as text and/or graphics on a screen associated with the drive-thru station.

As described, an offer may be printed on a paper substrate (e.g., a receipt, a trayliner, a food container, a coupon), which in turn may be presented to the customer. The customer may then read the information on the substrate and make a decision to accept the offer at his leisure. This paper substrate may have printed thereon an indication of the activity to be performed and an indication of the benefit to be provided.

According to one embodiment, the paper substrate may also include additional information, such as (i) an advertisement; (ii) a discount promotion; (iii) instructions as to how a customer may accept the offer; (iv) instructions as to how a customer may obtain additional information about the offer (e.g., a phone number, a uniform resource locator (URL)); (v) information useful in performing an activity (e.g., survey questions to answer, a customer information form to fill out, the address of a retailer where the customer should purchase a product); (vi) games (e.g., puzzles and scratch-off games); and/or (vii) instructions on how the subsidizer may be contacted directly.

In one embodiment, a customer who receives an offer in accordance with the present invention may use his cellular telephone or another device to contact the subsidizer directly in order to accept an offer. In such an embodiment the subsidizer may provide the benefit defined by the offer to the customer (e.g., by crediting a credit card account provided by the customer for an amount). Alternatively, the subsidizer may provide a code to the customer, which code the customer may in turn provide to the retailer (e.g., via a POS device or a rebate device) as proof of having accepted the offer. The retailer, upon receiving such proof of offer acceptance, may then provide the benefit to the customer.

According to one embodiment, the offer is output to the customer by being printed on a receipt that is provided to the customer. This receipt may also include other information about the purchase the customer participated in, including a list of products purchased, a total cost, an indication of payment provided, a time of purchase, a POS device identifier, a POS device operator identifier and/or a customer identification number. Note that printing an offer on a receipt is particularly appropriate for offers in which the benefit relates to the purchase associated with the receipt. For example, a customer may purchase a hamburger, French Fries, and a soda, for a total of $4.59. At the bottom of his receipt for this purchase, the POS device or a peripheral device may print an offer, such as “Get the cost of your purchase ($4.59) refunded if you sign up for a free 3-month trial subscription to Autoweek™ magazine.”

Alternatively, an offer maybe presented to a customer in various other printed forms. For example, along with (or in lieu of) his receipt for a purchase, a customer may be given a paper substrate with an offer printed on it. For example, a customer at a quick service restaurant may be given a paper placemat that that has an offer printed on it. A paper placemat given to a customer at a restaurant may have a detachable portion (e.g., with perforated edges). This detachable portion may have the offer printed thereon. To accept the offer, the customer may tear the perforated or otherwise detachable portion away from the rest of the placemat. In another example, a quick service restaurant may serve a customer's meal on a plastic tray. This plastic tray may have an offer engraved, laminated, glued, printed, or otherwise presented on it.

In yet another example of a manner of visually outputting an offer to a customer, an offer may be printed on a container in which the customer's purchases are to be placed. For example, a retailer may provide a paper or plastic bag to a customer to carry her purchase. The offer may be printed on the outside of this bag. In another example,

a customer may be provided with a scratch-off game piece (e.g., printed on a piece of cardboard and/or on a food or other product package). The customer may then remove a scratch-off latex coating to reveal his offer. Embodiments in which a customer plays a game to reveal information about an offer may be particularly appealing to customers as they allow a customer to feel as though he has “won” an offer.

As described above, in one embodiment containers for food or other products may include offers. For example, an offer may be printed on a customer's drink cup or sandwich box at a quick service restaurant. Alternatively, a game piece describing the offer (e.g., such as a peel-off game piece), may be attached to a product container. For example, McDonalds™ sometimes promotes a version of the game Monopoly™, wherein various food containers provided by McDonalds™ (e.g., French Fry containers, drink cups, Big Mac™ containers) have attached to them a peel-off game piece. Customers peel off the game pieces to reveal which Monopoly™ property they have obtained. Some of the game pieces (or collections of game pieces) entitle the customers to prizes. The present invention could be practiced by printing offers on similar peel-off game pieces attached to product containers. Any other appropriate substrate besides paper may be printed, engraved, or otherwise marked with information about an offer and provided to a customer (e.g., plastic, cloth, metal).

According to one embodiment, the paper or other substrate on which an offer is output may be specially sized to fit in the cash drawer of a POS device. For example, a receipt or other piece of paper on which an offer is printed may be approximately the same size as a personal check or a dollar bill so that it will fit into the bill section of a cash drawer. In another example, a tear-away portion of a customer's trayliner may be approximately the same size as a dollar bill.

According to one embodiment, an offer may be output (e.g., printed) at substantially the same time as the purchase is being completed by the customer. For example, a printer attached to a POS device or a POS peripheral device may print an offer that may be presented to a customer by a cashier as the customer is paying for the purchase (or right before or after the customer pays for the purchase).

Alternatively, the offer may be output (e.g., printed) at a time substantially before the purchase is completed by the customer but provided to the customer at the time of the purchase. For example, trayliners may be printed for a restaurant by a commercial printer. These trayliners may have offers printed on them. Different offers may be printed on each trayliner or set of trayliners. For example, a first set of trayliners may have a first offer or group of offers printed thereon and a second set of trayliners may have a second offer or group of offers printed thereon. Accordingly, once it is determined in step 810 which offer is to be output to the customer, step 815 may comprise directing an operator of a POS device, another employee, or a dispensing device, which trayliner to provide to the customer. For example, a first set of trayliners may be printed with an offer for customers whose purchase total is between $3.00 and $5.00 and a second set of trayliners may be printed with an offer for customers whose purchase total is between $5.00 and $10.00. In such an example, it is determined which trayliner is to be provided to the customer based on the purchase total of the purchase being completed by the customer. Similarly, different product containers or sets of product containers may have printed thereon or attached thereto different offers. Accordingly, an operator of a POS device, another employee, or a dispensing device may be instructed which product container to provide to the customer based on predetermined rules.

In another example of offers being output at a time substantially different from a time at which the offers are provided to customers, a grocery store may have offers printed on brown paper bags or plastic bags used by customers for carrying purchases. Each morning (or other appropriate time interval), the grocery store may stamp offers on the bags to be used.

According to one embodiment, an offer may include an identification code. This identification code may be any information useful in identifying the offer (e.g., a number, an alphanumeric code, a bar code, a series of bits on a magnetic stripe). Identification codes may be particularly useful in allowing a customer to quickly accept an offer, as described below. According to one embodiment, identification codes may be unique for each offer output to a customer. Alternatively, offers that define the same benefit to be provided in exchange for a commitment to the same activity may be associated with the same identification code.

If in step 815, the offer is output to the customer in an audio manner, a message conveying the offer may be output to the customer via a speaker associated with a POS device or a speaker associated with a drive-thru station. Alternatively, an operator of a POS device may be prompted to speak the offer to the customer. In some embodiments, an offer is output in both an audio and visual manner simultaneously. For example, an offer may be conveyed in an audio manner to an operator of a POS device via headphones worn by the operator, prompting the operator to speak the offer to the customer. Simultaneously, or close in time, the offer may be visually output to the customer (e.g., via a display screen associated with the POS device, wherein the display screen is visible to the customer).

In step 820 it is determined that a customer is accepting an offer output to the customer in a previous purchase. For example, after receiving an offer and considering it (e.g., while enjoying his meal at a restaurant), a customer may decide to accept the offer. Accepting the offer means that the customer agrees to receive the benefit defined by the offer and commits to the activity defined by the offer. It should be noted that a substantial amount of time may pass between the performance of step 815 and step 820. Further, step 815 and step 820 may be performed by different devices. For example, step 815 may be performed by a first POS device while step 820 may be performed by a rebate device or a second POS device.

According to one embodiment, a customer may accept an offer by bringing a paper or other substrate on which the offer is printed to a POS device. The customer may provide the paper to an employee operating the POS device and indicate that he would like to accept the offer. Alternatively, the customer may verbally describe an offer that was previously displayed to the customer and tell an employee that he would like to accept the offer. In either embodiment, the employee may indicate the customer's desire to accept an offer by entering an indication into a POS device, a POS peripheral device or a rebate device. In yet another embodiment a customer may be provided with an offer that is associated with a magnetic stripe card. In order to indicate acceptance of such an offer the customer may swipe the card through a magnetic stripe reader associated with a POS device or rebate device. The magnetic stripe may contain an offer identifier that identifies the offer the customer is accepting. A magnetic stripe reader may be operable to read the identifier and communicate it to a POS device, a POS peripheral device, a rebate device, and/or another computing device (e.g., central computer and/or a POS server).

An employee of the retailer at which the offer is being accepted may process an offer acceptance in the appropriate manner. The process of processing an acceptance of an offer may comprise, for example, (i) receiving an indication of an acceptance of an offer; (ii) identifying the offer; and (iii) identifying the customer.

Receiving an indication of an acceptance of an offer comprise receiving an offer identifier or a signal indicating that an offer is being accepted by a customer. The offer identifier or signal may be entered into a POS device by an operator of the POS device. For example, a customer may hand a paper on which an indication of the offer is printed to an operator of a POS device. The operator may, in response, actuate a predetermined button of the POS device or an appropriately designated area of a touch screen associated with the POS device (e.g., an “offer accepted” button or area). Alternatively, the operator may enter an offer identifier associated with the offer being accepted into the POS device (e.g., via a keyboard or bar code scanner, depending on the format of the identifier).

Receiving a signature of a customer or an indication that a signature of a customer has been received may also be an indication that a customer has accepted an offer. For example, a customer may be required to sign a screen of an electronic signature pad associated with a POS device or a rebate device in order to accept an offer. Or a customer may be required to sign a paper (e.g., the paper on which the offer was printed for the customer) and the operator of the POS device may indicate that the customer has signed the paper by actuating a button or area of a touch screen associated with the POS device. Note that the indication of offer acceptance may be provided by the customer himself or by an employee of the retailer.

Alternatively, a customer may indicate that he would like to reject an offer. This may be appropriate in an embodiment of the invention in which it is assumed that a customer accepts an offer unless the customer specifies otherwise (a.k.a. “a default-accepted offer”).

According to one embodiment, information about accepted offers may be stored in a redemption database, such as the one illustrated in tabular representation 600 shown in FIG. 6. The redemption database may be useful, for example, in tracking offers that have been accepted, benefits that have been provided and activities that have been performed.

Note that in some embodiments, an input device for indicating an acceptance of an offer may be operated by either the customer or an employee of the retailer. For example, if the customer is accepting an offer via an input device of a rebate device, the customer may be operating the input device (e.g., a touch screen, keyboard, or bar code scanner). If the customer is accepting the offer via an input device of a POS device, an employee of the retailer may be operating the input device (e.g., a touchscreen or keyboard). Alternatively, both the customer and an employee may be operating an input device when processing an offer acceptance. For example, if a customer is accepting an offer at a POS device, an employee of the retailer may scan a bar code associated with the offer into the POS device (e.g., using a first input device which is a bar code scanner) and the customer may indicate acceptance of the offer by signing a screen of an electronic signature pad associated with the POS device (e.g., using a second input device which is the electronic signature pad). Note that the input device being used by an employee of the retailer may or may not be the same input device or type of input device as the input device being used by a customer.

In another example where multiple input devices are used to identify an offer, an employee of the retailer may utilize more than one input device to process the acceptance of an offer. For example, a customer may have the option of choosing one of a plurality of activities that are defined by an offer and printed on a paper provided to the customer during a previous purchase. To identify the activity selected by the customer, an employee of the retailer may scan a bar code identifying the offer with a bar code scanner and then use a keypad to indicate which activity the customer is committing to in exchange for the benefit defined by the offer.

According to one embodiment, a POS device may include an output device (e.g., a video display) to display information about an offer. Displaying information about the offer may be helpful in allowing the customer or an employee to verify that the correct offer has been identified. The customer or employee may then be prompted to indicate that this is indeed the offer that the customer would like to accept.

As described above, step 820 of determining that a customer is accepting an offer may comprise identifying the customer who is accepting the offer. In accordance with an embodiment, identifying a customer may help track offers that have been accepted and avoid fraudulent use of the system.

Identifying a customer may comprise determining one or more of the following data associated with the customer: (i) the customer's name; (ii) a driver's license number of the customer; (iii) a license plate number and state of a car associated with the customer; (iv) the customer's social security number; (v) the customer's telephone number (e.g., home, work, or cellular); (vi) an address associated with the customer (e.g., e-mail or postal); (vii) a frequent shopper identifier or other identifier associated with the customer; (viii) a biometric of the customer (e.g., a picture of the customer's face, the customer's fingerprint); and (ix) a payment identifier associated with the customer (e.g., a credit card number). The data determined to identify the customer may be stored for subsequent use (e.g., in a customer database, such as the one illustrated in tabular representation 700).

Note that it may not be necessary to uniquely identify the customer. For example, two or more customers may share an automobile that is identified by a single license plate number.

According to one embodiment, a customer may be identified using an input device. For example, a customer may write his name and address on a piece of paper and hand this piece of paper to an operator of a POS device. The operator may then use a keyboard to type this information into the POS device. In another example, a video camera at drive-thru window may capture an image of a customer's license plate number to determine the customer's identity. In yet another example, a camera may capture an image of a customer while the customer is accepting an offer at a POS device or a rebate device and/or at a time when a benefit as defined by the accepted offer is being provided to the customer. An image file of the customer may be stored (e.g., in the customer database) for use, for example, in resolving a future dispute by a person that they did not accept an offer.

According to one embodiment, determining a payment identifier may be part of processing an acceptance of an offer. For example, in accordance with at least one embodiment, a customer may receive an immediate benefit for an activity to be performed in the future. For example, the customer may make a forward commitment to perform an activity. In such an embodiment, a customer may agree to perform an activity, receive a benefit based on this commitment, and then not perform the activity (e.g., because the customer forgot to perform the activity or changed his mind about performing the activity). To avoid this type of problem, forward commitments may be penalty-secured.

One method of penalty-securing a forward commitment is to obtain a payment identifier (e.g., a credit card or debit card account number) from a customer. This payment identifier may subsequently be used for assessing a penalty to the customer if the customer does not perform an activity he agree to. The payment identifier may also be used to credit a benefit to a customer.

A payment identifier may be any information that is useful in obtaining a payment from the customer or for providing a payment to a customer. Examples of payment identifiers include: (i) a credit card number; (ii) a debit card number; (iii) another type of financial account number; and (iv) a name and billing address.

According to one embodiment, a customer may provide a payment (e.g., cash) instead of a payment identifier. This payment may then be refunded if the customer performs the activity defined by the offer.

A payment identifier for a customer may be determined in a variety of different ways, including through an input device at a point of sale terminal. For example, a customer may slide his credit card through a magnetic stripe reader associated with a POS device or a rebate device. In a second example, an operator of a POS device may input an account number provided by the customer using a keyboard of the POS device.

According to one embodiment, the authenticity of a payment identifier provided by a customer may be verified before a customer is allowed to accept an offer. For example, a customer may provide a credit card number as a payment identifier. To verify the credit card number, a credit card authentication system may be contacted to make sure that the customer's available credit limit is high enough to cover any charges that the customer may incur and/or that the credit card number is for a valid account. Additionally, a portion of the customer's credit limit may be reserved to ensure that there will be available funds to cover any penalty the customer may incur.

Obtaining a payment identifier from a customer may also be useful in an embodiment of the invention in which a customer is asked to perform an activity of purchasing a product. For example, the customer may supply a payment identifier to pay for the product that she is purchasing. This payment identifier may be charged accordingly for the cost of the product and/or stored in a database for later processing. According to one embodiment, a payment identifier for a customer may be stored in a customer database (e.g., such as the one illustrated in tabular representation 700).

In step 825, proof of the previous purchase in which the customer participated is received. This step may comprise, for example, receiving an identifier that uniquely identifies the previous purchase of the customer. For example, the customer may be required to provide a receipt of the previous purchase when accepting the offer. Data on the receipt may be utilized to identify the previous purchase. For example, the receipt may include a unique purchase identifier. The purchase identifier may be in the form of a bar code and/or alphanumeric characters readable by a person and/or a computer. The identifier may be input to a POS device (e.g., by an operator of the POS device scanning the bar code or keying in the identifier) or a rebate device (e.g., by a customer scanning the bar code or keying in the identifier). Based on the identifier, information related to the purchase (e.g., products purchased and/or the purchase total) may be retrieved from a database or memory (e.g., a purchase database, such as the one illustrated by tabular representation 400). In embodiments wherein the benefit is a return of the purchase total, retrieving the purchase total may be of particular utility. In embodiments where the benefit is determined based on one or more products included in the customer's purchase, retrieving the products included in the previous purchase may be of particular utility.

In embodiments where an offer may only be accepted within a predetermined period of time from a specified event (e.g., from the time the previous purchase was completed by the customer), the time of the previous purchase may be compared to the current time, to verify that the offer may indeed be accepted by the customer at this time. An operator of a POS device may perform such a verification by visually inspecting the receipt and reading the time of the previous purchase printed on the receipt and comparing that time to the current time. Alternatively, the time of the previous purchase may be retrieved from memory (e.g., from a purchase database) based on the purchase identifier and automatically compared to the current time by the device at which the offer is being accepted (e.g., a POS device or a rebate device).

In some embodiments, the customer may simply be required to provide the receipt of the previous purchase to an operator of a POS device. The operator may simply verify that the receipt is a valid receipt of the retailer (e.g., that it isn't a receipt from another retailer) and proceed with processing the customer's acceptance of the offer. The operator may confiscate the receipt (e.g., to prevent its future use to accept another offer by the customer) and place it in the cash register drawer of the POS device or another designated location.

Requiring a customer to provide proof of a previous purchase in which the customer participated may be important in preventing over-acceptance of offers and abuse of the system of the present invention by customers.

Other methods of receiving proof of a previous purchase include (i) providing a copy of a credit card statement or other financial statement; (ii) providing a proof of purchase portion of a product container; and (iii) providing a frequent shopper card or other documentation that reflects a previous purchase (e.g., a card that is stamped or punched each time a customer makes a qualified purchase, as utilized by some retailers). Another method may comprise presentation (e.g., verbal) of a non-unique purchase identifier by the customer, wherein the non-unique purchase identifier had been previously assigned by the retailer to the customer's purchase. For example, some restaurants (e.g., pizza restaurants) assign a number to each purchase (e.g., a number between and including 1 and 100). Once the highest assignable number (e.g., 100) is reached, the restaurants typically return to the first assignable number (e.g., 1) and reuse the numbers for subsequent purchases. In another method of providing proof of purchase, a customer may provide information describing a purchase (e.g. one or more products included in the purchase, the amount of change received) which may be used to search through a memory of completed purchases. Alternatively, the customer may provide a password (e.g., provided to the customer when the customer completed the previous purchase) as proof of a previous purchase.

In step 830, a benefit to be provided to the customer is determined. As described above, the offer provided to the customer and being accepted by the customer defines the benefit to be provided to the customer in exchange for the customer's commitment to the activity defined by the offer. Determining a benefit to provide to the customer may comprise retrieving a record from the offer database based on the offer identifier and identifying the benefit specified in the record. Determining a benefit to provide to the customer may further comprise (in embodiments where the offer does not specify a particular benefit but defines it in terms of a characteristic of the purchase) retrieving data associated with the purchase during which the offer was output (e.g., based on a purchase identifier provided by the customer). The particular benefit may be determined by utilizing the definition of the benefit in the offer and applying it to the purchase data. For example, if the offer defines the benefit as a refund of the purchase total of the previous purchase, the purchase total may be retrieved based on the purchase identifier (or determined directly from the receipt or other proof of the previous purchase provided by the customer) and determined to be the benefit in step 830.

In step 835, the benefit is provided to the customer. According to one embodiment of the invention, a benefit may be provided to a customer immediately after he accepts an offer. This embodiment may be particularly appealing to customers because it allows them to obtain immediate gratification for accepting an offer.

As described above, a benefit may provided to a customer by the retailer. Examples of benefits that may be provided to the customer at the retailer as the customer accepts the offer include: (i) cash taken from the cash drawer of a POS device (e.g., wherein the cash amount is based on the purchase total of the previous purchase in which the customer participated; (ii) crediting a financial account of the customer with a monetary amount; (iii) discounted or free products (e.g., a free meal or free dessert); (iv) coupons for products or services sold by the retailer; (v) coupons for products or services sold by other retailers (e.g., retailers within geographical proximity); (vi) preferential future service (e.g., access to an express line); and (vii) tickets or other merchandise that can easily be stored behind the counter or printed in real-time by a POS device or a rebate device.

Cash benefits may be particularly appealing to customers in a retail environment. However, note that if cash is removed from a POS device and provided to customers as a benefit, it would be helpful to have a mechanism to account for the cash removed from the POS device. For example, the cash amount of the benefit provided may be stored in a redemption database, such as the one shown in FIG. 5. The total cash amount of benefits provided from a particular POS device or rebate device may then be totaled and reconciled with the amount of cash in the drawer at the end of the day.

In another example of tracking cash benefits provided from a device, the proof of the previous purchase and/or the paper or other substrate on which the offer that a customer accepted may be retained and stored for subsequent verification. For example, an operator of a POS device may be required to obtain and store the receipt of the customer's previous purchase along with the paper on which the offer was printed and store it in the register drawer of the POS device whenever a cash benefit is provided to a customer. This method may be similar to the one currently used for coupons, wherein a cashier is required to obtain and store the coupon via which a customer obtained a discount on a current purchase. In such embodiments, at the end of the day, the total value of benefits defined by offers redeemed at a particular POS device or rebate device may be summed with the total cash in the drawer to determine the total revenues for the day. In such an embodiment, the register tape or memory of a POS device or a rebate device may reflect each cash amount provided to a customer as a negative amount. This mechanism may be similar to how a return of merchandise is noted on a register tape of a POS device. However, in the present invention the cash is being provided out of the drawer in exchange for a commitment from a customer rather than for a return of merchandise. Further, unlike a return of merchandise system, in the present invention the retailer that provides the cash amount as a benefit to a customer is reimbursed for a portion of the cash amount, the entire cash amount, or an amount greater than the cash amount, by a subsidizing entity.

In embodiments where the benefit is an amount of cash to be provided out of a cash drawer of a POS device, the step 835 may comprise authorizing the operator of the POS device to take out the amount of cash from the drawer. For example, a locking mechanism of the cash register drawer may be released or the operator otherwise authorized to open the drawer. Further, the operator may be instructed to open the drawer and to provide a specified amount of cash from the drawer to the customer. Such instructions may be provided to the operator via a visual prompt displayed on a screen of the POS device visible to the operator. Such instructions may also be provided to the operator via an audio prompt output to the operator via headphones worn by the operator. The amount of cash that the operator is authorized to provide to the customer may also be output to the customer that is to receive the benefit (e.g., via a display such as a screen facing the customer and/or via a speaker). This may be done to help the customer verify that the operator is dispensing the appropriate amount of cash to the customer.

In embodiments where the benefit is an amount of cash to be dispensed from a rebate terminal, the step 835 may comprise activating a money dispensing mechanism (e.g., similar to that found in an automated teller machine (ATM)). For example, a customer may input a receipt into the rebate device, the rebate device may determine from the receipt the purchase total of the previous purchase and cause a cash amount that is the purchase total to be dispensed to the customer from a compartment of the rebate device.

Alternatively, a benefit maybe provided to a customer at times other than when a customer accepts an offer, as described above. For example, a benefit may be provided to a customer at a time the customer performs the activity defined by the offer the customer accepted.

Alternatively, the controller may determine that no benefit should be provided to a customer. This could happen for a variety of reasons, including: (i) an activity not being performed; (ii) an activity being performed in an unsatisfactory manner; (iii) an activity being started but not completed; and (iv) the benefit being provided to another party instead (e.g., in an embodiment where customers compete for benefits).

According to one embodiment, a customer may also receive one or more additional benefits from a subsidizer or other party. For example, a customer may accept an offer to get $2 cash if she signs up for a free 3-issue trial subscription to Home Living magazine. In this example, the $2 cash benefit is provided by a retailer, the signing up for the trial subscription is the activity, and the 3 free issues are an additional benefit provided by a subsidizer (Home Living magazine).

According to one embodiment, the central computer or another device may store information about benefits that are provided. For example, a redemption database may store an indication of benefits that have been provided to customers who have accepted offers.

In step 840, the customer is committed to the activity defined by the offer the customer accepted. This step may comprise, for example, storing an indication of the customer's acceptance in a redemption database or other form of memory. This step may also comprise outputting a verification of the customer's commitment to the customer.

Further, step 840 may comprise transmitting an indication of the customer's commitment to another entity. For example, an indication of the customer's commitment may be transmitted to the central computer and/or a subsidizing entity associated with the offer the customer accepted and/or an entity associated with the activity the customer committed to (if different from the subsidizing entity). In some embodiments the customer commits to performing an activity in the future and the provision of the benefit is penalty secured. In such embodiments, the step 840 of committing the customer to the activity may comprise assessing a charge to a payment identifier provided by the customer, reserving a portion of a credit limit of a credit card provided by the customer as a payment identifier, or freezing funds of a debit card or checking account provided by the customer as a payment identifier.

According to one embodiment, the retailer may transmit information to at least one subsidizer associated with an offer (e.g., to a subsidizer device). The subsidizer device may in turn store this information in a database (not shown). The subsidizer may then use this information to track a customer's performance of an activity specified in the offer.

In one embodiment, the retailer may transmit information about the customer to at least one subsidizer. For example, the retailer may transmit to the subsidizing entity an indication of the customer's payment identifier, and/or name and home address. As noted above, a payment identifier provided by a customer may be useful in ensuring that the customer performs an activity defined in an offer (e.g., following through on a forward commitment to perform an activity or purchasing a product).

Transmitting a customer's payment identifier to a subsidizer is particularly appropriate for embodiments of the invention in which the subsidizing entity tracks or enables a customer's performance of an activity defined in an offer. Allowing a subsidizing entity to track or enable the performance of an activity by a customer may be preferable for a number of reasons. For example, it may simplify accounting performed by the central computer, the retailer, or the subsidizer. Also, it may reduce the amount of work performed by the central computer, thereby making it easier to maintain the central computer. Further, it may help to clarify to the customer that he is performing an activity for the subsidizing entity and not for the retailer. Finally, it may allow the subsidizing entity to establish a relationship with the customer, which may be helpful in enabling future transactions between the two parties.

According to one embodiment, a subsidizing entity may verify the authenticity of a payment identifier received from the central computer (e.g., if the central computer or other device had not already done so upon receiving the payment identifier). Examples of a subsidizing entity verifying the authenticity of a payment identifier are analogous to those described above with respect to activities of a retailer. In one embodiment, both the subsidizing entity and the retailer may verify the authenticity of a customer's payment identifier.

According to one embodiment, a customer may have agreed to perform an activity of purchasing a product from a subsidizing entity. In such an embodiment, the subsidizing entity may charge the cost of the product to the account specified by the payment identifier or send a bill for the cost of the product to the address provided as part of the payment identifier. Note that it is also possible for the retailer or central computer to charge the cost of the product to the account specified by the payment identifier or send the bill to the address and then pay this amount to the subsidizing entity. However, this embodiment may be inconvenient because it requires an additional accounting by the retailer and the subsidizing entity, and it may be unclear to a customer from whom he purchased the product.

Note that offers for benefit in accordance with the present invention may be presented in various environments wherein it may be desirable to allow a person being presented with the offer to have time to consider the offer. Applicants have recognized that environments wherein customers purchase consumable goods are ones where customers may be particularly motivated to obtain a refund of the cost of the consumable item by accepting an offer in accordance with embodiments of the present invention.

For example, an offer may be printed on admission tickets for sporting events, movies, amusement parks, etc. For example, the offer may be printed on the back of the ticket or on a portion of the ticket retained by the customer after entering the event or location the ticket is for). The customer may then review the offer at his leisure (e.g., between innings, during a lull in the game, while waiting in line for concessions). If the customer decides to accept the offer, he may bring the ticket to a ticket booth, concession stand, or other location in the stadium and receive a benefit. A customer in such a situation may be particularly motivated by a benefit that is a refund of the price of the ticket since the customer, after experiencing the event or location that the ticket is for, is realizing that she would like to still have the money that she paid for the ticket and/or is feeling guilty for spending the money on the ticket.

Similarly, a customer that has purchased a transit ticket may be motivated to obtain a refund of the cost of the ticket by accepting an offer in accordance with embodiments of the present invention. For example, an airline ticket, bus pass, or train pass may include a description of an offer printed on the back of the ticket. A customer may review this offer at his leisure (e.g., while in transit to his destination). If the customer desires to accept the offer, he may bring the ticket to an appropriate location (e.g., the ticket booth at his destination, a store in an airport mall) to receive a benefit. Similarly, a description of an offer may be printed on a ticket jacket (e.g., such as the ones typically used to hold airline tickets).

A customer ordering a meal at a restaurant where the customer does not provide payment for the meal until the customer finishes the meal may also be particularly motivated to avoid the upcoming cost. Such a customer may be presented with offers in accordance with the present invention, for example, on a menu, placemat, tablecloth or other table covering. The customer may thus consider the offers as she is eating her meal and contemplating the upcoming bill.

Another example of an environment where a customer may be particularly motivated accept an offer in accordance with embodiments of the present invention to obtain a refund of funds expended for a consumable item, is a retailer where customers rent a movie on DVD. A rental receipt, DVD case, DVD, coupon, or other item provided to the customer during his rental transaction may include a description of an offer. The customer may review this offer at his leisure (e.g., while waiting for pizza delivery before watching the movie). If the customer decides to accept the offer, he may bring the rental receipt or other item back to the local video store and receive a benefit at the point-of-sale of the local video store. Other examples of rental items include car rentals (e.g., a coupon may be attached to the car keys or printed on a rental agreement). In one example, a rental item may include a display (e.g., an LCD display) that may display an offer to a customer.

Applicants have also recognized that offers for benefits in accordance with the present invention may also be successfully utilized in environments where a person is going inevitably going to incur a charge unless the customer accepts an offer in accordance with the present invention.

One example of such an environment is a retailer that provides estimates for necessary services—For example, a customer at a garage may receive an estimate for getting his oil changed or having a dent removed from his car. This estimate may include a description of an offer. If the customer wants to accept the offer, he may indicate this when he pays for the service performed (e.g., the oil change).

Another example of an environment where a customer may be particularly motivated to avoid an inevitable upcoming charge is a hotel, where customers typically to not provide payment until checking out of the hotel. For example, an electronic keycard that a hotel guest uses to access his room may have an offer printed on it. A customer may then review this offer at his leisure (e.g., while watching TV in his hotel room, while riding a hotel elevator). If the customer wants to accept the offer he may do so when checking out of the hotel (e.g., by returning the keycard to the hotel front desk and obtaining a benefit).

Another example of an environment where a customer may be particularly motivated to avoid an inevitable charge is the mail-order environment. For example, a packing slip from a mail order purchase may be printed with an offer. To accept this offer, the customer may return the packing slip to the mail order retailer (e.g., when mailing a product back to the retailer to return it). Providing a customer a benefit of free shipping on a returned item may be particularly motivational.

Yet another example of an environment where a customer may be particularly motivated to avoid an inevitable charge is a parking garage, where a customer typically does not provide payment until driving out of the garage. For example, a customer who parks his car in the garage at a shopping mall may be required to get his parking pass validated or pay for parking. This parking pass may be printed with a description of an offer. The customer may review the offer at his leisure (e.g., while shopping in the shopping mall). If the customer decides to accept the offer, he may bring the parking pass to an appropriate location (e.g., the exit gate of the parking garage, a nearby retail store).

Similarly, a customer that has incurred a late charge (e.g., for a movie rental or a book from a library) may be particularly motivated to avoid the charge and thus accept an offer in accordance with the present invention. In such an embodiment, the offer may be provided to the customer at the time she initially rents/borrows the movie or book or at the time the customer returns the movie or book and pays the late charge. In the latter example, the customer may obtain a refund of the late charge paid by accepting the offer at a later time.

In yet another example of an environment where the present invention may be practiced, a customer may purchase a textbook, compact disc, car, or other product and later resell this product to a used product retailer (e.g., a college bookstore, a used CD store, a used car dealer). The product may be printed with or otherwise describe an offer (e.g., an offer may be printed on the last page of the textbook or on the jewel case for a CD). If the customer later decides to sell the product (e.g., to a used bookstore or used CD store), then he may accept the offer by indicating this to the cashier at the used products store.

In yet another example of an environment where the present invention may be practiced, a customer may pawn an item (e.g., a television set) at a pawn shop and receive a pawn shop ticket that describes an offer. The customer may review the offer at his leisure (e.g., during the time between when he pawned his item and when he returns to the pawn shop to reclaim his item or pay interest on his item). If the customer wants to accept the offer, he may return to the point-of-sale at the pawn shop. Note that customers who pawn products may be particularly interested in receiving additional cash or in obtaining cash to pay interest on a pawned item.

In yet another example of an environment where the present invention may be practiced, a lottery ticket, instant lottery ticket (e.g., scratch-off ticket), sweepstakes ticket, bingo card, keno ticket, prize claim ticket, or slot machine cashless gaming receipt may be printed with a description of an offer (e.g., on the back of the ticket, underneath a scratch-off coating on the ticket). A customer who purchases, wins, or otherwise obtains the game ticket may review the offer at his leisure (e.g., before redeeming the ticket). If the customer decides to accept the offer described on the ticket, he may bring the ticket to an appropriate location (e.g., a retailer that provides cash for instant lottery tickets, a casino teller, a prize claim booth at a video arcade) to receive a benefit.

In yet another example of an environment where the present invention may be practiced, a recyclable can, bottle, or other container may have a printed label that describes an offer. A customer who purchases a product that is recyclable (e.g., a can of soda) may review this offer at his leisure (e.g., while enjoying his can of soda). If the customer wants to accept the offer, he may take the product to an appropriate recycling center (e.g., a supermarket, a TOMRA™ reverse vending machine) to receive a benefit based on the offer.

In yet another example of an environment where the present invention may be practiced, a customer may drop off photographic film at a developer, pharmacy, supermarket, or other location to have it developed. When dropping off the film, the customer may receive a claim ticket that facilitates the customer picking up his developed film. This claim ticket may include an offer that the customer can review at his leisure (e.g., while he is waiting for his film to be developed). If the customer desires to accept the offer, he may return to the film developer and present the claim ticket. In a related example, a printed photograph from a developer may have an offer printed on the back of the photograph. If a customer wants to accept the offer, he may bring the photograph back to the developer and receive a benefit (e.g., a free enlargement, discounted processing).

In yet another example of an environment where the present invention may be practiced, a customer may purchase a product online for pickup at a local store. In order to claim the product that he purchased online at the local store, the customer may print out a claim receipt from his personal computer. This claim receipt may include an offer that the customer can review at his leisure (e.g., before visiting the local store to pickup his product). If the customer desires to accept the offer, he may do so at the local store when picking up his product.

In yet another example of an environment where the present invention may be practiced, a doctor may write a prescription for a customer that describes one or more drugs, therapies, or other treatments that the customer should obtain. This prescription may include a description of an offer (e.g., offers may be preprinted on doctor's prescription pads). The customer may then review this offer at his leisure (e.g., after leaving the doctor's office but before obtaining the treatment). If the customer decides to accept the offer, he may provide the prescription to a treatment provider (e.g., a pharmacist) to receive a benefit (e.g., a discount on prescription drugs).

In yet another example of an environment where the present invention may be practiced, a customer may purchase a product in a refillable container (e.g., a refillable pill bottle). This refillable container may be printed with a description of an offer. The customer may review this offer at his leisure (e.g., while using the product in the refillable container). If he decides to accept the offer, he may return the refillable container to a refill center (e.g., a pharmacy), receive a refill of the container, and receive a benefit based on the offer.

What is claimed is:

1. A method for providing a benefit to a customer at a point-of-sale, comprising:
determining an offer that a customer desires to accept by receiving an indication of the offer from the customer,
wherein the offer defines a benefit to be provided to the customer in exchange for the customer's commitment to an activity;
determining a purchase that the customer previously participated in;
determining a benefit to provide to the customer based on the purchase and the offer;
providing, at a point-of-sale, the benefit to the customer in exchange for the customer's commitment to the activity in accordance with the offer.

2. The method of claim 1, further comprising:
capturing identifying documentation of the customer to whom the benefit is provided.

3. The method of claim 2, wherein the step of capturing comprises:
capturing a photographic image of the customer.

4. The method of claim 2, wherein the step of capturing comprises:
capturing an identifier that identifies a financial account associated with the customer.

5. The method of claim 4, further comprising:
determining that the customer has not performed the activity in accordance with the offer; and
assessing a penalty to the financial account identified by the identifier.

6. The method of claim 5, wherein the step of assessing comprises:
assessing, to the financial account identified by the identifier, a penalty that is equivalent to the benefit.

7. The method of claim 2, wherein the step of capturing comprises:
capturing data indicative of how the customer may be contacted regarding the activity.

8. The method of claim 7, wherein the data comprises at least one of an electronic mailing address, a postal mailing address, and a telephone number.

9. The method of claim 1, wherein the step of determining an offer comprises:
determining, at the point-of-sale, an identifier that identifies the offer.

10. The method of claim 9, wherein the step of determining an offer comprises:
determining the identifier that identifies the offer by obtaining indicia printed on a document provided to the customer at a time of the previous transaction.

11. The method of claim 10, wherein the document comprises at least one of a receipt, a coupon, a brochure, a menu and a placemat.

12. The method of claim 1, wherein the step of determining a purchase comprises:
determining an identifier printed on a receipt of the purchase; and
determining data associated with the previous purchase based on the identifier.

13. The method of claim 12, further comprising:
determining that the customer has provided the receipt to an operator of the point-of-sale.

14. The method of claim 1, wherein the step of determining a purchase comprises:
determining a monetary amount associated with the purchase; and
wherein the step of determining a benefit comprises:
determining a benefit to provide to the customer based on the monetary amount and the offer.

15. The method of claim 1, wherein the step of determining a purchase comprises:
determining at least one product included in the purchase.

16. The method of claim 1, wherein the step of determining a benefit comprises:
determining an amount of cash to provide to the customer based on the purchase and the offer.

17. The method of claim 1, wherein the step of providing comprises:
causing an operator of a point-of-sale terminal to provide the benefit to the customer in exchange for the customer's commitment to the activity.

18. The method of claim 17, wherein the step of causing further comprises:
prompting the operator to provide, to the customer, an amount of cash that is the benefit.

19. The method of claim 1, wherein the activity comprises an activity that the customer is to perform at a time after a time at which the customer accepts the offer.

20. The method of claim 1, wherein the activity comprises an activity that the customer performs at a time substantially simultaneous to a time at which the customer accepts the offer.

21. The method of claim 1, wherein the benefit comprises a monetary amount that is greater than a purchase total of the purchase the customer previously participated in.

22. A method for providing a benefit to a customer at a point-of-sale, the method comprising:
receiving, at a time after a purchase is completed by a customer, an acceptance of an offer from the customer,
wherein the offer defines a benefit that is to be provided to the customer in exchange for the customer's commitment to an activity;
determining, based on a purchase total associated with the purchase, an amount of cash to provide to the customer, thereby determining the benefit;
providing, at a point-of-sale, the benefit to the customer;
documenting an identity of the customer to whom the benefit was provided;
storing an indication of the customer's acceptance of the offer; and
determining, based on the identity, whether the customer fulfilled the commitment to the activity in accordance with the offer.

23. The method of claim 22, further comprising:
determining a purchase at a point-of-sale terminal being completed by a customer; and
determining an offer to output to the customer.

24. The method of claim 22, further comprising:
outputting the offer to the customer.

25. The method of claim 24, wherein the step of outputting the offer to the customer comprises:
causing the offer to be printed on a receipt that is a record of the purchase.

26. The method of claim 24, wherein the step of outputting the offer to the customer comprises:
causing the offer to be printed on a paper placemat to be provided to the customer.

27. The method of claim 24, wherein the step of outputting the offer to the customer comprises:
causing the offer to be displayed to the customer at the point-of-sale.

28. The method of claim 24, wherein the step outputting the offer to the customer comprises:
causing the offer to be printed on a coupon provided to the customer at the time of the purchase.

29. The method of claim 22, wherein the step of documenting an identity of the customer comprises:
capturing a photographic image of the customer to whom the benefit was provided; and
storing the photographic image in association with an indication of the customer's acceptance of the offer.

30. A method for providing a benefit to a customer at a point-of-sale terminal, comprising:
receiving, at a point-of-sale terminal, a receipt of a purchase previously completed by a customer;
receiving, at a point-of-sale terminal, an identifier that identifies an offer that the customer desires to accept,
wherein the offer defines at least a portion of a purchase total associated with the previous purchase to be provided to the customer in exchange for the customer's commitment to an activity;
determining a current time;
determining a time at which the purchase was completed;
determining whether the current time is within a predetermined period of time from the time at which the purchase was completed;
determining an amount of cash to be provided to the customer, based on the at least a portion of the purchase total defined by the offer;
causing, if the current time is within the predetermined period of time from the time at which the transaction was completed, the amount of cash to be provided to the customer from a cash drawer of the point-of-sale terminal; and
registering the customer for the activity defined by the offer.

31. The method of claim 30, wherein the step of receiving, at a point-of-sale terminal, a receipt of a purchase further comprises:
determining, from the receipt, an identifier that identifies the purchase previously completed by the customer.

32. The method of claim 31, wherein the step of determining a time at which the purchase was completed comprises:
retrieving from a database, based on the identifier, a time at which the purchase was completed.

33. The method of claim 30, further comprising:
determining a purchase total paid by the customer when completing the previous purchase.

34. The method of claim 33, further comprising:
determining, from the receipt, an identifier that identifies the purchase; and
retrieving the purchase total from a memory based on the identifier that identifies the purchase.

35. The method of claim 30, wherein the step of determining a monetary amount comprises:
determining a price of a product purchased by the customer as part of the transaction.

36. The method of claim 30, wherein the step of determining an amount of cash comprises:
determining a monetary amount that is less than a purchase total paid by the customer when completing the previous purchase.

37. A method for providing an amount of cash to a customer, comprising:
determining an acceptance of an offer by a customer,
wherein the offer defines a benefit to be provided to the customer in exchange for a commitment from the customer to perform an activity;
determining an identifier that identifies the offer;
determining an identifier that identifies a purchase completed at a time before the current time;
determining an indication of an identity of a customer who is accepting the offer
determining an amount of cash to be provided to a customer, thereby determining the benefit of the offer;
authorizing the amount of cash to be removed from a cash drawer of a point-of-sale terminal and provided to the customer in exchange for the acceptance of the offer;
storing, in a memory associated with the point-of-sale register, an indication of the amount of cash as having been removed from the cash drawer of the point-of-sale terminal,
wherein the indication is stored in association with each of
the identifier that identifies the purchase,
the identifier that identifies the offer, and
the indication of the identity of the customer.

38. The method of claim 37, wherein the step of determining an acceptance comprises:
determining that a customer has provided an identifier that identifies the offer to an operator of the point-of-sale register.

39. The method of claim 37, further comprising:
receiving, from the customer, information indicative of how the customer may be contacted regarding the offer.

40. The method of claim 39, wherein the step of receiving comprises:
receiving, from the customer, at least one of a telephone number, a postal mailing address, and an electronic mail address.

41. The method of claim 39, wherein the step of receiving comprises:
receiving, from the customer, a form on which the customer filled out the information.

42. The method of claim 41, wherein the form comprises a portion of a paper placemat that had been provided to the customer.

43. The method of claim 41, wherein the form comprises a portion of a receipt that had been provided to the customer as a record of the purchase.

44. The method of claim 41, wherein the form comprises a coupon that had been provided to the customer when the customer had completed the purchase.

45. The method of claim 37, further comprising:
receiving, from the customer, an identifier that identifies a financial account associated with the customer.

46. A method for determining an offer to provide to a customer at a point-of-sale, the method comprising:
determining a purchase total of a purchase being completed by a customer;
determining at least one item included in the purchase;
determining an offer to provide to the customer based on at least one of the purchase total and the at least one item,
wherein the offer defines an amount of cash that is at least a portion of the purchase total to be provided to the customer from a cash drawer of a point-of-sale terminal in exchange for the customer's commitment to an activity, and
outputting the offer to the customer as the customer completes the purchase,
wherein the offer may only be accepted by the customer in a transaction other than the purchase.

47. The method of claim 46, wherein the step of outputting comprises:
printing the offer on a receipt provided to the customer as a record of the purchase.

48. The method of claim 46, wherein the step of outputting comprises:
printing the offer on a paper placemat for lining a tray on which the at least one product is to be placed.

49. The method of claim 46, wherein the step of outputting comprises:
causing the offer to be associated with a container of at least one food product included in the purchase.
